(19) United States
(12) Patent Application Publication
(10) Pub. No.: US 2026/0031879 A1
(43) Pub. Date: Jan. 29, 2026

(54) METHODS AND APPARATUSES FOR TRANSMITTING AND RECEIVING CHANNEL STATE INFORMATION AND COMMUNICATION SYSTEM

(71) Applicant: FUJITSU LIMITED, Kawasaki-shi (JP)

(72) Inventors: Qun ZHANG, Beijing (CN); Xin WANG, Beijing (CN); Jing ZHU, Beijing (CN); Meiyi JIA, Beijing (CN); Yiwen LU, Beijing (CN); Lei ZHANG, Beijing (CN)

(73) Assignee: FUJITSU LIMITED, Kawasaki-shi (JP)

(21) Appl. No.: 19/346,640

(22) Filed: Oct. 1, 2025

Related U.S. Application Data
(63) Continuation of application No. PCT/CN2023/086724, filed on Apr. 6, 2023.

(51) Int. Cl. H04B 7/06; H04L 41/16

(52) U.S. Cl. CPC H04B 7/0626; H04B 7/0639; H04L 41/16

(57) ABSTRACT

An apparatus for receiving channel state information (CSI), applicable to a network device, includes: first processor circuitry making the network device execute the following: transmitting information by the network device to a terminal equipment, at least a part of the information being one or more CSI reporting configurations, the one or more CSI reporting configurations being used for indicating the terminal equipment to transmit at least two of first channel state information (CSI), second CSI and third CSI; and receiving, by the network device, at least two of the first CSI, the second CSI and the third CSI transmitted by the terminal equipment, wherein at least two of the first CSI, the second CSI and the third CSI are generated based on at least a part of identical channel state information reference signals (CSI-RSs) and/or CSI-RS resources.

### CROSS-REFERENCE TO RELATED APPLICATION

This application is a continuation application under 35 U.S.C. 111(a) of International Patent Application PCT/CN2023/086724 filed on Apr. 6, 2023, and designated the U.S., the entire contents of which are incorporated herein by reference.

### TECHNICAL FIELD

This disclosure relates to the field of communication technologies.

### BACKGROUND

Multiple-input multiple-output (MIMO) technology is one of the key technologies for 5G mobile communication. MIMO is able to provide higher channel capacity, but the realization of the benefit depends on whether accurate channel state information may be acquired.

In the MIMO technology, a terminal equipment measures spatial channels and feeds channel state information (CSI) back to a network device. According to the channel state information reported by the terminal equipment, the network device may select an appropriate precoding matrix suitable for the terminal equipment in performing downlink transmission, thereby reducing a probability of receiving bit errors of the terminal equipment as much as possible.

A channel state information generation and feedback process may be summarized as follows. The network device transmits channel state information reference signals (CSI-RSs) to terminal equipments, and the terminal equipments estimate channels based on the received CSI-RSs to obtain estimation of a spatial channel matrix. The terminal equipments further utilize the estimated spatial channels to obtain CSI. In the New Radio (NR) technology, a feedback mode of CSI is implicit feedback, that is, the terminal equipments provide CSI in a form of recommending transmission parameters to the network device, the transmission parameters including a channel state information reference signal resource indicator (CQI), a precoding matrix indicator (PMI), a CSI-RS resource indicator (CRI), a synchronization signal block resource indicator (SSBRI), a layer indicator (LI), a rank indicator (RI), and physical layer RSRP (L1-RSRP), etc. A base station may directly use the parameters recommended by the terminal equipment to perform downlink transmission, or, it may not use the recommended parameters.

In a frequency division duplex (FDD) system, for a downlink, when the network device uses information of downlink channels for precoding, the terminal equipment is needed to feed back the downlink channel state information to the network device via an uplink. However, as the information of downlink channels is proportional to the number of antennas of the network device, in a scenario of massive MIMO, the huge number of antennas of the network device will lead to a very large amount of feedback on the channel state information of the downlink channels. Enhanced codebooks (such as eType II codebooks) for downlink feedback has been designed in the Third Generation Partnership Project (3GPP), in which feedback amount of channel state information is reduced through frequency domain compression. However, for valuable uplink resources, there is still a need to further reduce the amount of uplink feedback.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

With the development of artificial intelligence/machine learning (AI/ML) technologies, applying the AI/ML technologies to physical layers of wireless communication to solve difficulties in related methods has become a current technological direction.

FIG. 1 is a schematic diagram of CSI feedback based on AI/ML. An AI/ML module may include an AI/ML-based CSI generation portion and an AI/ML-based CSI reconstruction portion, wherein the AI/ML-based CSI generation portion includes an AI/ML model, the AI/ML model including an AI/ML encoder and a quantizer. In addition, and further including a preprocessing module. The AI/ML-based CSI reconstruction portion includes an AI/ML reconstruction model, the AI/ML reconstruction model including a quantizer and an AI/ML decoder, and further including a post-processing module.

As shown in FIG. 1, in operation 101, the terminal equipment side uses the AI/ML-based CSI generation portion to process and obtains CSI, and the network device receives the CSI via air interface; and in operation 102, the network device uses the AI/ML-based CSI reconstruction portion to process the received CSI, and obtains recovered CSI.

It was found by the inventors that in the related art, a method of how to monitor CSI feedback by a network device has not been standardized yet.

In order to solve at least one of the above problems or other similar problems, embodiments of this disclosure provide methods and apparatuses for receiving and transmitting channel state information and a communication system. In the method, a terminal equipment is indicated to transmit at least two of first CSI, second CSI and third CSI to a network device, hence, the network device may monitor a performance of a model for generating CSI according to the received CSI.

According to one aspect of the embodiments of this disclosure, there is provided an apparatus for receiving channel state information (CSI), applicable to a network device, the apparatus including a first processing unit, the first processing unit making the network device execute the following operations:
transmitting information by the network device to a terminal equipment, at least a part of the information being one or more CSI reporting configurations, the one or more CSI reporting configurations being used for indicating the terminal equipment to transmit at least two of first channel state information (CSI), second CSI and third CSI; and
receiving, by the network device, at least two of the first CSI, the second CSI and the third CSI transmitted by the terminal equipment,
wherein at least two of the first CSI, the second CSI and the third CSI are generated based on at least a part of identical channel state information reference signals (CSI-RSs).

According to another aspect of the embodiments of this disclosure, there is provided an apparatus for transmitting channel state information (CSI), applicable to a terminal equipment, the apparatus including a second processing unit, the second processing unit making the terminal equipment execute the following operations:
receiving, by the terminal equipment, information transmitted by a network device, at least a part of the information being one or more CSI reporting configurations, the one or more CSI reporting configurations being used for indicating the terminal equipment to transmit at least two of first channel state information (CSI), second CSI and third CSI; and
transmitting at least two of the first CSI, the second CSI and the third CSI by the terminal equipment,
wherein at least two of the first CSI, the second CSI and the third CSI are generated based on at least a part of identical channel state information reference signals (CSI-RSs).

An advantage of the embodiments of this disclosure exists in that the terminal equipment is indicated to transmit at least two of first CSI, second CSI and third CSI to the network device, hence, the network device may monitor a performance of a model for generating CSI according to the received CSI.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in more than one other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of more than one other features, integers, steps, components or groups thereof.

### BRIEF DESCRIPTION OF THE DRAWINGS

Elements and features depicted in one drawing or embodiments of the disclosure may be combined with elements and features depicted in more than one additional drawings or embodiments. Moreover, in the drawings, like reference numerals designate corresponding parts throughout the several views and may be used to designate like or similar parts in more than one embodiment.

FIG. 1 is schematic diagram of performing CSI feedback based on AI/ML;

FIG. 2 is a schematic diagram of a communication system of this disclosure;

FIG. 3 is a schematic diagram of the method for receiving channel state information (CSI) of the embodiments of the first aspect of this disclosure;

FIG. 4 is a schematic diagram of the method for transmitting channel state information (CSI) of the embodiments of the second aspect of this disclosure;

FIG. 5 is a schematic diagram of the apparatus for receiving channel state information (CSI) of the embodiments of the third aspect of this disclosure;

FIG. 6 is a schematic diagram of the apparatus for transmitting channel state information (CSI) of the embodiments of the fourth aspect of this disclosure;

FIG. 7 is a schematic diagram of the terminal equipment of the fifth aspect of this disclosure; and

FIG. 8 is a schematic diagram of the network device of the fifth aspect of this disclosure.

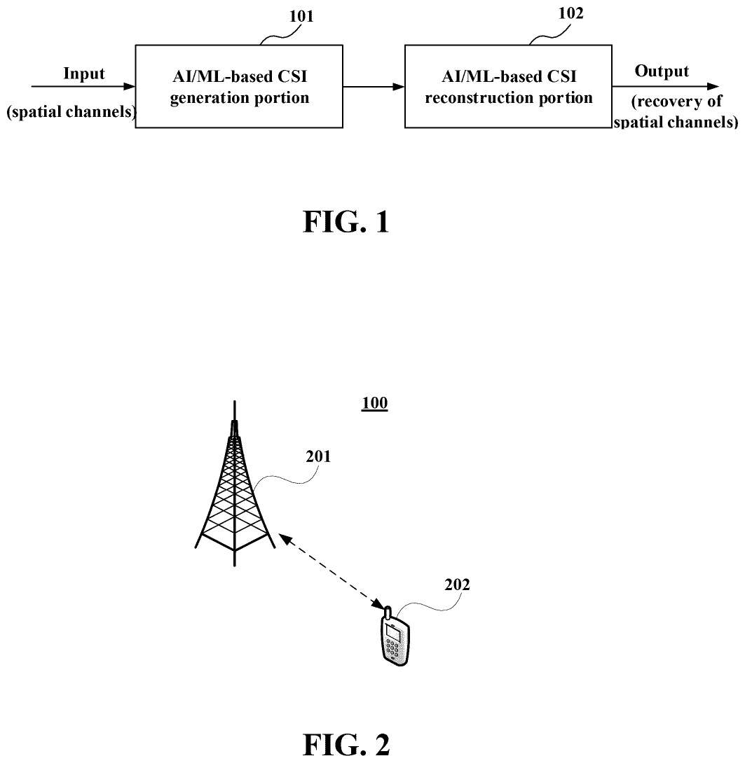

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of more than one relevantly listed terms. Terms “contain”, “include” and “have” refer to existence of stated features, elements, components, or assemblies, but do not exclude existence or addition of more than one other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, and new radio (NR), etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or more than one network devices including those described above. The term “user side” or “terminal side” or “terminal equipment side” refers to a side of a user or a terminal, which may be a UE, and may include more than one terminal equipments described above.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, high-layer signaling may be, for example, radio resource control (RRC) signaling; for example, it is referred to an RRC message, which includes an MIB, system information, and a dedicated RRC message; or, it is referred to an as an RRC information element (RRC IE). High-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

FIG. 2 is a schematic diagram of a communication system of this disclosure, in which a case where a terminal equipment and a network device are taken as examples is schematically shown. As shown in FIG. 2, the communication system 100 may include a network device 201 and a terminal equipment 202 (for the sake of simplicity, an example having only one terminal equipment is schematically given in FIG. 2).

In the embodiments of this disclosure, existing traffics or traffics that may be implemented in the future may be performed between the network device 201 and the terminal equipment 202. For example, such traffics may include but not limited to enhanced mobile broadband (eMBB), massive machine type communication (MTC), and ultra-reliable and low-latency communication (URLLC), etc.

The terminal equipment 202 may transmit data to the network device 201, such as in a grant or grant-free manner. The network device 201 may receive data transmitted by one or more terminal equipments 202, and feed back information to the terminal equipment 202, such as acknowledgement (ACK)/non-acknowledgement (NACK) information, and the terminal equipment 202 may acknowledge to terminate a transmission process, or may perform transmission of new data, or may perform data retransmission.

In the following description of this disclosure, an artificial intelligence (AI) model may also be referred to as an artificial intelligence/machine learning (AI/ML) model, and they are interchangeable.

In the embodiments described below, signaling transmitted by the network device to the terminal equipment may be transmitted via downlink control information (DCI), a media access control control element (MAC CE), and/or radio resource control (RRC) signaling.

In the following embodiments of this disclosure, there exists a pairing relationship between an AI/ML-based CSI generation portion and an AI/ML-based CSI reconstruction portion, the former being applicable to a terminal equipment side, and the latter being applicable to a network device side. If the terminal equipment uses an AI/ML-based CSI generation portion, the network device must use an AI/ML-based CSI reconstruction portion paired with the AI/ML-based CSI generation portion to successfully reconstruct channel information. And if the network device uses an AI/ML-based CSI reconstruction portion, the terminal equipment must use an AI/ML-based CSI generation portion paired with the AI/ML-based CSI reconstruction portion to successfully reconstruct channel information at the network device side.

The AI/ML-based CSI generation portion includes an AI/ML model, which may be used to generate more than one of precoding matrix information, a rank indicator (RI), a layer indicator (LI), a channel resource indicator (CRI), and a channel quality indicator (CQI). In addition, the RI, LI, CRI and CQI may not be generated by the AI/ML model. For example, the AI/ML-based CSI generation portion may further include more than one of a module generating an RI, a module generating an LI, a module generating a CRI, and a module generating a CQI. The AI/ML-based CSI generation portion may further include other modules, such as a module for truncating bit sequences.

The information of the AI/ML-based CSI generation portion may be composed of AI/ML model information and/or information of the module generating an RI and/or information of the module generating an LI and/or information of the module generating a CRI and/or information of the module generating a CQI and/or information of a module truncating a bit sequence and/or information of other functional modules (if any).

The AI/ML model may include three parts, a preprocessing module, an AI/ML encoder and a quantizer. Therefore, AI/ML model information may include preprocessing module information, AI/ML encoder information and quantizer information. For example, the AI/ML model information may be described by “preprocessing module #2, AI/ML encoder #4, quantizer #A”. In addition, the preprocessing module, AI/ML encoder and quantizer may be regarded as a whole to annotate the AI/ML model information, that is, the AI/ML model information may also be expressed as, for example, AI/ML model information #4, etc.

The AI/ML-based CSI reconstruction model of the AI/ML-based CSI reconstruction portion paired with the AI/ML-based CSI generation portion may also include three parts, a dequantizer, an AI/ML decoder, and a post-processing module. Therefore, the AI/ML reconstruction model information may include dequantizer information, AI/ML decoder information, and post-processing module information. For example, the AI/ML reconstruction model information may be described by “dequantizer #B, AI/ML decoder #1, post-processing module #2”. In addition, the AI/ML reconstruction model information may also be expressed as, for example, AI/ML reconstruction model #1, or AI/ML model #1 in brief, so as to express the pairing relationship with AI/ML model #1 in the AI/ML-based CSI generation portion.

The AI/ML model may also be composed of two parts (for example, it has no preprocessing module, or a preprocessing module is included in the AI/ML encoder and is regarded as a whole with the AI/ML encoder), that is, the AI/ML model includes an AI/ML encoder and a quantizer. At this point, the AI/ML model information may be composed of AI/ML encoder information and quantizer information. The AI/ML-based CSI reconstruction model of the AI/ML-based CSI reconstruction portion paired with the AI/ML model may also consist of two parts, a quantizer and an AI/ML decoder. At this point, the AI/ML reconstruction model information consists of quantizer information and AI/ML decoder information. The preprocessing module may be included in the AI/ML encoder, or may not be included in the AI/ML encoder. The post-processing module may be included in the AI/ML decoder or may not be included in the AI/ML decoder.

The AI/ML model may also be composed of one part, that is, the AI/ML encoder and quantizer are regarded as a whole (for example, the AI/ML encoder and quantizer are inseparable and cannot be freely combined), and the AI/ML encoder may or may not include a preprocessing module. At this point, the AI/ML model information consists of one part only, for example, the AI/ML model information is AI/ML model #5. The AI/ML reconstruction model may also be composed of one part, that is, the quantizer and AI/ML decoder are regarded as a whole (for example, the AI/ML decoder and quantizer are inseparable and cannot be freely combined), and the AI/ML decoder may or may not include a post-processing module. At this point, the AI/ML reconstruction model information consists of one part only, for example, the AI/ML reconstruction model information is AI/ML reconstruction model #5, or AI/ML model #5 in brief, so as to express the pairing relationship with AI/ML model #5 in the AI/ML-based CSI generation portion.

In the embodiments of this disclosure, it is assumed that frequency domain resources are fixed, that is, carrier frequencies, subcarrier spacings and bandwidths are fixed. In addition, this disclosure is not limited thereto, for example, description of the embodiments is also applicable to scenarios where at least one of the carrier frequencies, subcarrier spacings and bandwidths is not fixed.

In various embodiments of this disclosure, reporting may refer to an action of transmitting information by the terminal equipment to the network device. For example, reporting CSI by the terminal equipment may refer to transmitting CSI by the terminal equipment to the network device.

### Embodiments of a First Aspect

The embodiments of the first aspect provide a method for receiving channel state information (CSI), applicable to a network device.

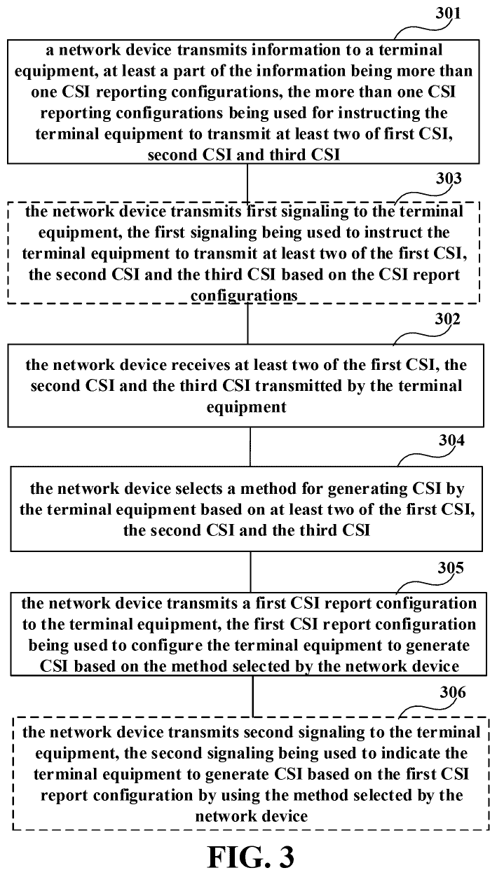

FIG. 3 is a schematic diagram of the method for receiving channel state information (CSI) of the embodiments of the first aspect of this disclosure. As shown in FIG. 3, the method includes:
301: a network device transmits information to a terminal equipment, at least a part of the information being one or more CSI reporting configurations, the one or more CSI reporting configurations being used for indicating the terminal equipment to transmit at least two of first channel state information (CSI), second CSI and third CSI; and
302: the network device receives at least two of the first CSI, the second CSI and the third CSI transmitted by the terminal equipment.

In the embodiments of the first aspect of this disclosure, at least two of the first CSI, the second CSI and the third CSI are generated based on at least a part of identical channel state information reference signals (CSI-RSs) and/or CSI-RS resources.

In the embodiments of the first aspect, at least two of the first CSI, the second CSI, and the third CSI are generated based on at least a part of the identical channel state information reference signals (CSI-RSs) and/or CSI-RS resources,
wherein, “at least a part of the identical channel state information reference signals (CSI-RSs)” refers to that CSI-RSs used to measure channels (such as non-zero power CSI-RSs) are identical, and the CSI-RS resources refer to resources of the at least a part of the identical CSI-RSs.

In at least some embodiments, at least a part of information of the first CSI is bit information of a spatial channel matrix or bit information of a right singular vector of the spatial channel matrix.

For example, the spatial channel matrix may be a spatial channel matrix obtained by the terminal equipment by performing channel estimation by using the CSI-RSs transmitted by the network device it receives, and the right singular vector is a right singular vector of the spatial channel matrix.

The spatial channel matrix may be an index of the spatial channel matrix, and/or the right singular vector may be an index of the right singular vector.

The bit information is obtained by scalar quantization and/or a third method. The third method is a codebook specified in 3GPP standardization or a method obtained by expanding a value range of at least one parameter of a codebook specified in 3GPP standardization.

The codebook specified in the 3GPP standardization is at least one of a Type I single-panel codebook, a Type I multi-panel codebook, a Type II codebook, a Type II port selection codebook, an enhanced Type II codebook, an enhanced Type II port selection codebook, or a further enhanced Type II port selection codebook.

The second CSI is CSI obtained by a first method. At least a part of the first method is a method based on an artificial intelligence (AI/ML) model. The first method is configured by the network device, or is specified in a protocol, or is determined and reported by the terminal equipment to the network device.

The third CSI is CSI obtained by a fourth method. At least a part of the fourth method is a codebook specified in the 3GPP standardization.

In this disclosure, the first CSI may be referred to as ground-truth CSI, the second CSI may be referred to as CSI generated based an AI/ML method, and the third CSI may referred to as CSI generated based on a codebook method.

Bitwidths of the CSI generated based on an AI/ML method and the CSI generated based on a codebook method are identical, or the former is longer than the latter by not more than N bits, or the latter is longer than the former by not more than M bits. M and N may be identical or different, which are non-negative integers, and their values may be 0, 1, 2, . . . , 20. For example, M=3, and N=4, and for another example, M=1, and N=1.

In the description of the embodiments of this disclosure, at least two of the first CSI, the second CSI and the third CSI may be: the first CSI and the second CSI, or, the second CSI and the third CSI, or, the first CSI and the third CSI, or, the first CSI, the second CSI and the third CSI.

In at least one embodiment, at least two of the first CSI, the second CSI and the third CSI are included in one or more CSI reports.

In at least one embodiment, in operation 301, the network device may transmit the information to the terminal equipment via first radio resource control (RRC) signaling.

The number of CSI report configurations included in the information may be one, or two, or three. For example:
when the number of CSI report configurations is one, the CSI report configuration is used to configure the terminal equipment to transmit at least two of the first CSI, the second CSI and the third CSI; or
when the number of CSI report configurations is two, one CSI report configuration is used to configure the terminal equipment to transmit the first CSI and the second CSI, and the other CSI report configuration is used to configure the terminal equipment to transmit the third CSI; or
when the number of CSI report configurations is two, one CSI report configuration is used to configure the terminal equipment to transmit the first CSI and the third CSI, and the other CSI report configuration is used to configure the terminal equipment to transmit the second CSI; or
when the number of CSI report configurations is two, one CSI report configuration is used to configure the terminal equipment to transmit the second CSI and the third CSI, and the other CSI report configuration is used to configure the terminal equipment to transmit the first CSI; or
when the number of CSI report configurations is three, the three CSI report configurations are respectively used to configure the terminal equipment to transmit the first CSI, the second CSI and the third CSI.

In at least one embodiment, the first RRC signaling indicates the terminal equipment to transmit at least two of the first CSI, the second CSI and the third CSI.

In addition, this disclosure is not limited thereto, and information containing one or more CSI report configurations may also be transmitted via the first RRC signaling, and the first signaling indicates the terminal equipment to transmit at least two of the first CSI, the second CSI and the third CSI.

As shown in FIG. 3, the method further includes:
303: the network device transmits first signaling to the terminal equipment, the first signaling being used to indicate the terminal equipment to transmit at least two of the first CSI, the second CSI and the third CSI based on the CSI report configurations.

The first signaling includes downlink control information (DCI) and/or a media access control control element (MAC CE).

Operation 303 may be performed before operation 302.

In at least one embodiment, as shown in FIG. 3, the method further includes:
304: the network device selects a method for generating CSI by the terminal equipment based on at least two of the first CSI, the second CSI and the third CSI.

Operation 304 may be performed after operation 302. In operation 304, similarities between the first CSI, the second CSI and the third CSI may be compared to select the method for generating CSI. For example, the second CSI and the first CSI are compared, and if a difference therebetween is greater than a threshold, a method for generating CSI based on codebooks is selected; otherwise, a method for generating CSI based on AI/ML is selected. For another example, the second CSI and the third CSI are compared respectively with the first CSI, and if the third CSI is closer to the first CSI, the method for generating CSI based on codebooks is selected; otherwise, the method for generating CSI based on AI/ML is selected.

In at least one embodiment, as shown in FIG. 3, the method further includes:
305: the network device transmits a first CSI report configuration to the terminal equipment, the first CSI report configuration being used to configure the terminal equipment to generate CSI based on the method selected by the network device; and
306: the network device transmits second signaling to the terminal equipment, the second signaling being used to indicate the terminal equipment to generate CSI based on the first CSI report configuration by using the method selected by the network device.

With operations 304, 305 and 306, the network device may monitor or set or switch the methods for generating CSI by the terminal equipment (such as models used by the terminal equipment).

In this disclosure, operation 306 may be absent, that is, in a case where the terminal equipment receives the first CSI report configuration transmitted by the network device, it may generate CSI according to the method configured by the first CSI report configuration.

In this disclosure, operations 301-306 may be repeated to dynamically detect and switch the methods for generating CSI by the terminal equipment. In each time of performing operations 301-306, the terminal equipment may be indicated to transmit at least two of the first CSI, the second CSI and the third CSI in identical or different manners. For example, in a time of performing operations 301-306, the terminal equipment may be indicated via the first RRC signaling to transmit at least two of the first CSI, the second CSI and the third CSI. Therefore, operation 303 is not executed, that is, operations 301, 302, 304, 305 and 306 are executed. For another example, in a time of performing operations 301-306, the terminal equipment may be indicated via the first signaling (such as DCI or an MAC CE) to transmit at least two of the first CSI, the second CSI and the third CSI. Therefore, operation 303 is executed, that is, operations 301, 303, 302, 304, 305 and 306 are executed.

In addition, a part of operations 301-306 may be executed, such as repeatedly executing operations 301 and 302 or repeatedly executing operations 301, 303 and 302, so as to obtain at least two of the first CSI, the second CSI and the third CSI, and monitor the methods for generating CSI by the terminal equipment (such as a model used by the terminal equipment).

This disclosure shall be further described below with reference to various embodiments. In the following embodiments, description is sometimes given by taking that the terminal equipment transmits three of the first CSI, the second CSI and the third CSI as an example, and contents of the description are also applicable to the case where two of the first CSI, the second CSI and the third CSI are transmitted.

### Embodiment 1

In at least one implementation, the first RRC signaling may indicate the terminal equipment to transmit at least two of the first CSI, the second CSI and the third CSI. For example, the first RRC message configures CSI triggering states for the terminal equipment, the number of CSI report configurations to which each triggering state corresponds being:
for reporting semi-persistent CSI via a PUSCH: 1;
for aperiodic CSI: more than 1.

In some implementations, the method for the network device to configure the terminal equipment to report “true CSI” (CSI generated based on “AI/ML”) is to add a field to the CSI report configurations. Adding a field to a CSI-ReportConfig information element is used to indicate the terminal equipment to report “true CSI” (“CSI generated based on AI/ML”). For example, a codebook configuration (codebookConfig) field may be added to indicate that a mode for generating precoding matrix information is true CSI (or CSI generated based on AI/ML). For example, codebookConfig-groundtruthCSI (codebookConfig-ai) is added to the CSI-ReportConfig information element, which may also be in other names. Changes to the CSI-ReportConfig information element are shown in table 2 and table 3, in which changed (newly-added) parts are underlined.

In the embodiments of this disclosure, “Need R/S/M” denotes Need R or Need S or Need M.

TABLE 2
CSI-ReportConfig information element (a codebook configuration field
to which CSI generated based on AI/ML corresponds is added)

-- ASN1START
-- TAG-CSI-REPORTCONFIG-START

| CSI-ReportConfig ::= | SEQUENCE { | |
|---|---|---|
| reportConfigID | CSI-ReportConfigId, | |
| carrier | ServCellIndex | OPTINAL, --Need S |

...,

| | | |
|---|---|---|
| codebookConfig | CodebookConfig | OPTINAL, --Need R |

...,

| | | |
|---|---|---|
| codebookConfig-ai | CodebookConfig-ai | OPTIONAL, |

--Need R/S/M

}
-- TAG-CSI-REPORTCONFIG-STOP
-- ASN1STOP

The codebook configuration field to which CSI generated based on AI/ML corresponds is added in table 2.

TABLE 3
CSI-ReportConfig information element (a codebook configuration field to which true CSI corresponds is added)

-- ASN1START
-- TAG-CSI-REPORTCONFIG -START

| CSI-ReportConfig ::= | SEQUENCE { | |
|---|---|---|
| reportConfigID | CSI-ReportConfigId, | |
| carrier | ServCellIndex | OPTINAL, |

--Need S
...,

| | | |
|---|---|---|
| codebookConfig | CodebookConfig | OPTINAL, --Need R |

...,

| | | |
|---|---|---|
| codebookConfig-groundtruthCSI | CodebookConfig-groundtruthCSI | OPTIONAL, --Need R/S/M |

}
-- TAG-CSI-REPORTCONFIG-STOP
-- ASN1STOP

The codebook configuration field to which true CSI corresponds is added in table 3.

In some implementations, other fields may also be added, such as a report quantity for reporting ‘true CSI’. For example, reportQuantity-groundtruthCSI is added to CSI-ReportConfig information element, which may also be in other names, and values thereof are some combinations of CSI. An example and a naming mode thereof are cri-RI-LI-PMI-CQI-Quantization (which may also be in other names), which denotes that the CSI reported by the terminal equipment indicated by the network device includes a CRI, an RI, an LI, a PMI and a CQI and a quantization mode of the true CSI (selected and reported by the terminal equipment). Changes to the CSI ReportConfig information element are shown in Table 4, in which changed (newly-added) parts are underlined.

TABLE 4
CSI-ReportConfig information element (a field of
the report quantity of the true CSI is added)

-- ASN1START
-- TAG-CSI-REPORTCONFIG-START

| CSI-ReportConfig ::= | SEQUENCE { | |
|---|---|---|
| reportConfigID | CSI-ReportConfigId, | |
| carrier | ServCellIndex | OPTINAL, |

--Need S
...,

| | | |
|---|---|---|
| codebookConfig | CodebookConfig | OPTINAL, --Need R |

...,

| | |
|---|---|
| reportQuantity-groundtruthCSI | CHOICE { |

```
      ...
  }
OPTIONAL, -- Need R/S/M
}
-- TAG-CSI-REPORTCONFIG-STOP
-- ASN1STOP
```

The field of the report quantity of the true CSI is added in table 4. An example of values of the report quantity of the true CSI may include at least one of:
cri-RI-PMI-CQI-Quantization;
cri-RI-i1-Quantization;
cri-RI-i1-CQI-Quantization;
cri-RI-CQI-Quantization;
cri-RSRP-Quantization;
ssb-Index-RSRP-Quantization;
cri-RI-LI-PMI-CQI-Quantization;
cri-SINR-Quantization;
ssb-Index-SINR-Quantization.

PMI refers to a right singular vector and/or spatial channel matrix of the spatial channel matrix obtained in the quantization method, and at least one of a CRI, an RI, an LI, a CQI, an i1, RSRP, ssb-Index or an SINR is obtained based on the right singular vector and/or spatial channel matrix of the spatial channel matrix obtained in the quantization method.

For another example, in the CSI generated based on AI/ML, a possibly added field is the report quantity of the CSI generated based on AI/ML, and a method for naming the field is “reportQuantity-ai”. The network device may indicate the terminal equipment to report an AI/ML model ID used by the latter, and reportQuantity-ai is added, and values thereof are some combinations of CSI. An example and a naming mode thereof are cri-RI-PMI-CQI-AIID-r19ai (which may also be in other names), which denotes that the CSI reported by the terminal equipment indicated by the network device includes a CRI, an RI, a PMI and a CQI and an AI/ML model ID, wherein at least one of the CRI, RI, PMI, CQI, LI, i1, RSRP, ssb-Index or SINR is generated based on the AI/ML method. Changes to the CSI-ReportConfig information element are shown in table 5, in which changed (newly-added) parts are underlined.

TABLE 5
CSI-ReportConfig information element (a field of the report
quantity of the CSI generated based on AI/ML is added)

| -- ASN1START | | |
|---|---|---|
| -- TAG-CSI-REPORTCONFIG-START | | |
| CSI-ReportConfig ::= | SEQUENCE { | |
| reportConfigID | CSI-ReportConfigId, | |
| carrier | ServCellIndex | OPTINAL, |
| --Need S | | |
| ..., | | |
| codebookConfig | CodebookConfig | OPTINAL, --Need R |
| ..., | | |
| reportQuantity-ai-r19 | CHOICE { | |
| ... | | |
| } | | |

OPTIONAL, -- Need R/S/M
}
-- TAG-CSI-REPORTCONFIG-STOP
-- ASN1STOP

The field of the report quantity of the CSI generated based on AI/ML is added in Table 5. An example of values of the report quantity (reportQuantity-ai-r19) of the true CSI may include at least one of:
cri-RI-PMI-CQI-AIID-r19ai;
cri-RI-i1-AIID-r19ai;
cri-RI-i1-CQI-AIID-r19ai;
cri-RI-CQI-AIID-r19ai;
cri-RSRP-AIID-r19ai;
ssb-Index-RSRP-AIID-r19ai;
cri-RI-LI-PMI-CQI-AIID-r19ai;
cri-SINR-AIID-r19ai;
sb-Index-SINR-AIID-r19ai.
   PMI refers to the precoding matrix information generated based on the AI/ML method, and at least one of a CRI, an RI, an LI, a CQI, an i1, RSRP, ssb-Index or an SINR is obtained based on the AI/ML method.

In some implementations, the CSI report configuration configured by the network device does not include a value of the report quantity of the CSI generated based on AI/ML, nor does it include a value of a report quantity of true CSI, and includes only a value of ReportQuantity or ReportQuantity-r16 or ReportQuantity-r17. At this time, report quantities of the true CSI, the CSI generated based on AI/ML and the CSI generated based on codebooks are specified by ReportQuantity of the value of ReportQuantity-r16 or ReportQuantity-r17 configured in the CSI report configuration. For example, in a CSI report configuration, the terminal equipment is indicated to report the true CSI, the CSI generated based on AI/ML and the CSI generated based on codebooks, and includes reportQuantity=‘cri-RI-PMI-CQI’. The CSI report transmitted by the terminal equipment to the network device includes a CRI, an RI, a PMI and CQI generated based on a traditional method (such as codebooks). The CSI report further includes second CRI, a second RI, precoding matrix information generated based on AI/ML and second CQI, wherein one or more of the second CRI, the second RI and the second CQI are generated in the AI/ML method. The CSI report further includes third CRI, a third RI, precoding matrix information to which true CSI corresponds, and third CQI, wherein one or more of the third CRI, the third RI and the third CQI are generated in the method for generating the true CSI. For example, the precoding matrix information to which the true CSI corresponds is a right singular vector of a spatial channel matrix estimated by the terminal equipment according to a CSI-RS, each element of the right singular vector being denoted by a float32 floating-point number. The third CQI is generated by using the right singular vector denoted by the float32 floating-point number. In some implementations, the CSI report configuration configured by the network device includes the value of ReportQuantity or ReportQuantity-R16 or ReportQuantity-R17. The CSI report configuration further includes the value of the report quantity of the CSI generated based on AI/ML and/or the value of the report quantity of the true CSI. At this time, the report quantity of the CSI based on codebooks is specified by the value of ReportQuantity or ReportQuantity-R16 or ReportQuantity-R17 configured in the CSI report configuration, the report quantity of the CSI generated based on AI/ML is specified by the value of the report quantity of the CSI generated based on AI/ML configured in the CSI report configuration, and the report quantity of the true CSI is specified by the value of the report quantity of the CSI generated based on AI/ML configured in the CSI report configuration. For the case where the CSI report configuration does not include the value of the report quantity of the CSI generated based on AI/ML, the CSI generated based on AI/ML is in accordance with the provisions of the report quantity of the CSI based on codebooks. For the case where the CSI report configuration does not include the value of the report quantity of the true CSI, the true CSI is in accordance with the provisions of the report quantity of the CSI based on codebooks. For example, in a CSI report configuration, the terminal equipment is indicated to report the true CSI, the CSI generated based on AI/ML and the CSI generated based on codebooks, and includes reportQuantity=‘cri-RI-PMI-CQI’ and reportQuantity-groundtruthCSI=‘cri-RI-PMI-CQI-Quantization’, and the CSI report transmitted by the terminal equipment to the network device includes the CRI, RI, PMI and CQI generated based on a traditional method (such as codebooks). The CSI report further includes second CRI, a second RI, precoding matrix information generated based on AI/ML and second CQI, wherein one or more of the second CRI, second RI and second CQI are generated in an AI/ML method. The CSI report further includes third CRI, a third RI, precoding matrix information to which the true CSI corresponds, third CQI and a quantization method used in generating the precoding matrix information to which the true CSI corresponds, such as float32. One or more of the third CRI, third RI and third CQI are generated in the method for generating the true CSI.

In some implementations, other fields may be added, such as a report configuration type (ReportConfigType). For example, for a case of true CSI, a periodic report, such as periodic-groundtruthCSI, and/or a semi-persistent report on a PUCCH, such as semiPersistentOnPUCCH-groundtruthCSI, and/or a semi-persistent report on a PUSCH, such as semiPersistentOnPUSCH-groundtruthCSI, and/or an aperiodic report, such as aperiodic-groundtruthCSI, may be added to the CSI-ReportConfig information element. Each of these four may also be in other names. Table 6 is an example of adding a report configuration type (reportConfigType) of the true CSI to the CSI-ReportConfig information element. The example includes semi-persistently reporting the true CSI on the PUSCH; however, it is not limited thereto. In the underlined braces ‘{ }’ in Table 6, contents that may be contained are one or two of the following two.
(1) reportSlotOffsetListDCI-0-2-groundtruthCSI SEQUENCE (SIZE (1 . . . maxNrofUL-Allocations-groundtruthCSI)) OF INTEGER(0 . . . 32) OPTIONAL,—Need R/S/M (2) reportSlotOffsetListDCI-0-1-groundtruthCSI SEQUENCE (SIZE (1 . . . maxNrofUL-Allocations-groundtruthCSI)) OF INTEGER(0 . . . 32) OPTIONAL—Need R/S/M

TABLE 6
CSI-ReportConfig information element (a report configuration type of the true CSI is added)

-- ASN1START
-- TAG-CSI-REPORTCONFIG-START

| CSI-ReportConfig ::= | SEQUENCE { | |
|---|---|---|
| reportConfigID | CSI-ReportConfigId, | |
| carrier | ServCellIndex | OPTINAL, |

--Need S
...,

| | | |
|---|---|---|
| codebookConfig | CodebookConfig | OPTINAL, --Need R |

...,

| | |
|---|---|
| semiPersistentOnPUSCH-groundtruthCSI | SEQUENCE { |

...

| | |
|---|---|
| } | OPTIONAL, -- Need R/S/M |

...
}
-- TAG-CSI-REPORTCONFIG-STOP
-- ASN1STOP

For another example, for the case of the CSI generated based on AI/ML, a periodic report, such as periodic-ai, and/or a semi-persistent report on a PUCCH, such as semiPersistentOnPUCCH-ai, and/or a semi-persistent report on a PUSCH, such as semiPersistentOnPUSCH-ai, and/or an aperiodic report, such as aperiodic-ai, may be added to the CSI-ReportConfig information element. Each of these four may also be in other names. Table 7 is an example of adding a report configuration type (reportConfigType) of the CSI based on AI/ML to the CSI-ReportConfig information element. The example includes aperiodically reporting the CSI generated based on AI/ML; however, it is not limited thereto. In the underlined braces ‘{ }’ in Table 7, contents that may be contained are one or two of the following two.
(1) reportSlotOffsetListDCI-0-2-ai SEQUENCE (SIZE (1 . . . maxNrofUL-Allocations-r19ai)) OF INTEGER(0 . . . 32) OPTIONAL,—Need R/S/M
(2) reportSlotOffsetListDCI-0-1-ai SEQUENCE (SIZE (1 . . . maxNrofUL-Allocations-r19ai)) OF INTEGER(0 . . . 32) OPTIONAL—Need R/S/M

TABLE 7
CSI-ReportConfig information element (a report configuration
type of the CSI based on AI/ML is added)

-- ASN1START
-- TAG-CSI-REPORTCONFIG-START

| CSI-ReportConfig ::= | SEQUENCE { | |
|---|---|---|
| reportConfigID | CSI-ReportConfigId, | |
| carrier | ServCellIndex | OPTINAL, |

--Need S
...,

| | | |
|---|---|---|
| codebookConfig | CodebookConfig | OPTINAL, --Need R |

...,

| | |
|---|---|
| aperiodic-ai | SEQUENCE { |

...

| | |
|---|---|
| } | OPTIONAL, -- Need R/S/M |

...
}
-- TAG-CSI-REPORTCONFIG-STOP
-- ASN1STOP

In some implementations, a value range of an existing field may be expanded. For example, possible values thereof may be added to cqi-table to indicate a CQI table of the true CSI (a CQI table of the CSI generated by using AI/ML), such as adding “table-groundtruthCSI” (Table 8) or “table-ai” (Table 9) to cqi-table, wherein values of M and N are positive integers greater than or equal to 1, and M and N may be identical or different.

TABLE 8
CSI-ReportConfig information element (a report configuration
type of the CSI based on AI/ML is added)

-- ASN1START
-- TAG-CSI-REPORTCONFIG-START

| CSI-ReportConfig ::= | SEQUENCE { | |
|---|---|---|
| reportConfigID | CSI-ReportConfigId, | |
| carrier | ServCellIndex | OPTINAL, |

--Need S
...,

| | | |
|---|---|---|
| codebookConfig | CodebookConfig | OPTINAL, --Need R |

...,

| | |
|---|---|
| cqi-Table | ENUMERATED {table1, table2, table3, table4-r17, |

table-groundtruthCSI-1, table-groundtruthCSI-2, ..., table-groundtruthCSI-M}
OPTIONAL, -- Need R/S/M
...
}
-- TAG-CSI-REPORTCONFIG-STOP
-- ASN1STOP

TABLE 9
CSI-ReportConfig information element (a report configuration
type of the CSI based on AI/ML is added)

| -- ASN1START | | |
|---|---|---|
| -- TAG-CSI-REPORTCONFIG-START | | |
| CSI-ReportConfig ::= | SEQUENCE { | |
| reportConfigID | CSI-ReportConfigId, | |
| carrier | ServCellIndex | OPTINAL, |
| --Need S | | |
| ..., | | |
| codebookConfig | CodebookConfig | OPTINAL, --Need R |

| ..., | |
|---|---|
| cqi-Table | ENUMERATED {table1, table2, table3, |
| | table4-r17, table-ai-1, |
| table-ai-2,..., table-ai-N} | OPTIONAL, -- Need R/S/M |

...
}
-- TAG-CSI-REPORTCONFIG-STOP
-- ASN1STOP

In some implementations, other fields may be added, such as reporting a frequency domain report granularity (reportFreqConfiguration) of “the true CSI”. For example, reportFreqConfiguration-groundtruthCSI is added to the CSI-ReportConfig information element, which may also be in other names. It may include a frequency domain granularity of CQI, with a value of broadband CQI or sub-band CQI, and it may also include a frequency domain granularity of precoding matrix information, with a value of broadband precoding matrix information or subband precoding matrix information. For another example, a frequency domain report granularity (reportFreqConfiguration) of “the CSI generated based on AI/ML” is reported. For example, reportFreqConfiguration-ai is added to the CSI-ReportConfig information element, which may also be in other names. It may include a frequency domain granularity of CQI, with a value of broadband CQI or sub-band CQI, and it may also include a frequency domain granularity of precoding matrix information, with a value of broadband precoding matrix information or subband precoding matrix information.

In some implementations, the true CSI is as described in section 3.3 (before sub-section 3.3.1), and contents needing to be configured in a codebook configuration field (such as being named as codebookConfig-groundtruthCSI) include a field of the type of true CSI (which may be denoted by codebookType), which may be, for example, a spatial channel matrix (a raw channel matrix), or a right singular vector of a spatial channel matrix. Table 10 gives examples of a field of codebook types of a codebook configuration of the true CSI, denoted by underscores.

TABLE 10
CSI-ReportConfig information element (a field
of the type of the true CSI is added)

| -- ASN1START | |
|---|---|
| -- TAG-CODEBOOKCONFIG-START | |
| CodebookConfig ::= | SEQUENCE { |
| ... | |
| } | |
| CodebookConfig-r16 ::= | SEQUENCE { |
| ... | |
| } | |
| CodebookConfig-r17 ::= | SEQUENCE { |
| ... | |
| } | |
| CodebookConfig-v1730 ::= | SEQUENCE { |
| ... | |
| } | |
| CodebookConfig-groundtruthCSI ::= | SEQUENCE { |
| ... | |
| codebookType | CHOICE { |
| rawchannelmatrix | OPTIONAL, Need R/S/M |
| rightsingularvector | OPTIONAL, Need R/S/M |

...
}
...
}
-- TAG-CODEBOOKCONFIG-STOP
-- ASN1STOP

The contents needing to be configured further include a quantization method of the true CSI, which may be scalar quantization, that is, performing scalar quantization on components of the true CSI one by one, such as using float32 floating-point numbers, and int8 integers, etc.; and a codebook method may also be used for quantization, such as enhanced type II codebooks with 3GPP (or non-3GPP) standardized codebook parameters, or further enhanced type II port selection codebooks with 3GPP (or non-3GPP) standardized codebook parameters; however, it is not limited to these four possibilities. Table 11 gives examples of a field (quantizationType) of the quantization method of the codebook configuration of the true CSI, denoted by underscores, where, “scalar” denotes scalar quantization, and “PMIndex” denotes codebook method quantization, which may also be in other names.

TABLE 11
CodebookConfig information element

-- ASN1START
-- TAG-CODEBOOKCONFIG-START

| | |
|---|---|
| CodebookConfig ::= | SEQUENCE { |

...
}

| | |
|---|---|
| CodebookConfig-r16 ::= | SEQUENCE { |

...
}

| | |
|---|---|
| CodebookConfig-r17 ::= | SEQUENCE { |

...
}

| | |
|---|---|
| CodebookConfig-v1730 ::= | SEQUENCE { |

...
}

| | |
|---|---|
| CodebookConfig-groundtruthCSI ::= | SEQUENCE { |

...

| | |
|---|---|
| quantizationType | CHOICE { |
| scalar | OPTIONAL, Need R/S/M |
| PMIindex | OPTIONAL, Need R/S/M |

```
    ...
}
...
}
-- TAG-CODEBOOKCONFIG-STOP
  -- ASN1STOP
```

In some implementations, a CSI report may include more than two of the true CSI, the CSI generated based on AI/ML and the CSI generated in the codebook method.

For example, in the CSI report configuration, the network device configures one of the three fields, codebookConfig, codebookConfig-r16 and codebookConfig-r17. however, one of the three fields may be configured simultaneously with codebookConfig-groundtruthCSI and codebookConfig-ai, that is, the network device may simultaneously configure one of: codebookConfig, codebookConfig-r16, codebookConfig-r17, and/or codebookConfig-groundtruthCSI, and/or codebookConfig-ai.

For the configured report quantity, its value denotes a part of CSI reported by each type (more than two of the true CSI, the CSI generated based on AI/ML and the CSI generated based on the codebook method) included in the CSI report. For example, the network device configures the terminal equipment to report the true CSI in a CSI report, the CSI generated based on AI/ML and the CSI generated based on the codebook method. reportQuantity=‘cri-RI-PMI-CQI’ is configured in the CSI report configuration, which denotes reporting ‘cri-RI-PMI-CQI’ of the true CSI, reporting ‘cri-RI-PMI-CQI’ of the CSI generated based on AI/ML, and reporting ‘cri-RI-PMI-CQI’ of the CSI generated based on codebook method. ‘PMI’ in the true CSI denotes the precoding matrix information, which may be a result obtained by quantifying the value of the codebook configuration specified in the CSI report configuration in the quantization method specified in the CSI report configuration, such as the right singular vector of the spatial channel matrix, which uses float32 scalar quantization. ‘PMI’ of the CSI based on AI/ML may be precoding matrix information generated based on the AI/ML method.

In some implementations, a CSI report may only contain one of the true CSI, the CSI generated based on AI/ML and the CSI generated based on the codebook method.

For example, in the CSI report configuration, the network device configures one of the five fields, codebookConfig, codebookConfig-r16, codebookConfig-r17, codebookConfig-groundtruthCSI, codebookConfig-ai.

### Embodiment 2

In embodiment 2, the network device transmits the first signaling to the terminal equipment, the first signaling being used to indicate the terminal equipment to transmit at least two of the first CSI, the second CSI and the third CSI based on the CSI report configuration. The first signaling includes downlink control information (DCI) and/or a media access control control element (MAC CE).

In this disclosure, the first signaling is described by taking the DCI as an example, and the description is also applicable to the case where the first signaling is an MAC CE.

In some implementations, the first signaling (e.g. the DCI) indicates on and/or of AI/ML-based CSI feedback (such as being used for AI/ML model backoff and recovery). In this embodiment, the CSI-ReportConfig information element has been expanded, and generation of CSI based on AI/ML is supported.

In some implementations, a field is added to the DCI to indicate methods for generating CSI of all CSI reports under a CSI report configuration. The CSI of the CSI reports may include precoding matrix information and/or CQI, and uses 1 bit to describe that the methods for generating CSI of all CSI reports are based on the AI/ML method or the codebook method. For example, the bit is:
0: indicates precoding matrix information of all the CSI reports is generated in the AI/ML method, and at the same time, the method for generating CSI based on codebooks and/or reporting the true CSI is/are closed;
1: indicates that the AI/ML method and/or reporting the true CSI is/are closed, and the precoding matrix information of all the CSI reports is generated in the codebook method.

A type and parameters of the used codebook are determined by the CSI report configuration, that is, information on available codebooks is included in the CSI report configuration.

In some implementations, a field is added to the DCI to indicate methods for generating CSI of all CSI reports under a CSI report configuration. The CSI of the CSI reports may include precoding matrix information. For each CSI report, it uses 1 bit to describe whether the method for generating CSI is based the AI/ML method or the codebook method. For example, a CSI report configuration contains 8 CSI reports, including 2 periodic CSI reports, 1 semi-persistent CSI report reported on a PUCCH, 3 semi-persistent CSI reports reported on a PUSCH, and 2 aperiodic CSI reports. In the field added to the DCI, for each CSI report, 1 bit is used to indicate the method for generating used in the CSI report.
0: indicates that precoding matrix information of the CSI report is generated in the AI/ML method, and at the same time, the method for generating CSI based on codebooks and/or reporting the true CSI is/are closed;
1: indicates that the AI/ML method and/or reporting the true CSI is/are closed, and the precoding matrix information of the CSI report is generated in the codebook method.

A type and parameters of the used codebook are determined by the CSI report configuration, that is, information on available codebooks is included in the CSI report configuration.

That is, 8 bits are used to indicate methods for generating CSI used by the 8 CSI reports. Methods for generating CSI of all CSI reports may be denoted in a bitmap manner. For example, (0, 1, 1, 1, 0, 0, 0, 1) denote that CSI reports 0, 4, 5, 6 generate CSI by using the AI/ML method, and CSI reports 2, 3, 4, and 7 generate CSI by using the codebook method.

### Embodiment 3

In embodiment 3, the network device transmits DCI to the terminal equipment to indicate ON of AI/ML-based CSI feedback and/or OFF of feedback of the true CSI, the CSI generated based on AI/ML, and the CSI generated based on codebooks. In the embodiments of the first aspect, the CSI-ReportConfig information element has been expanded, and feedback of the true CSI is supported.

Similar to embodiment 2, 1 bit and a bitmap are used to indicate more than two of that all CSI reports under a CSI report configuration feed back the true CSI, the CSI generated based on AI/ML and the CSI generated based on codebooks.

In some implementations, a field is added to the DCI to indicate contents of all CSI reports under a CSI report configuration. The CSI of the CSI reports may include precoding matrix information and/or CQI, and uses 1 bit to describe the contents of all the CSI reports. For example, the bit is:
0: indicates that the contents of all the CSI reports contain feeding back the true CSI, the CSI generated based on AI/ML and the CSI generated based on codebooks;
1: maintain contents of an existing CSI report, which may be any one of true CSI, CSI generated based on AI/ML and CSI generated based on codebooks.

A type and parameters of the used codebook are determined by the CSI report configuration, that is, information on available codebooks is included in the CSI report configuration.

In some implementations, a field is added to the DCI to indicate contents of all CSI reports under a CSI report configuration. For each CSI report, it uses 1 bit to describe the contents of the CSI report. For example, a CSI report configuration contains 8 CSI reports, including 2 periodic CSI reports, 1 semi-persistent CSI report reported on a PUCCH, 3 semi-persistent CSI reports reported on a PUSCH, and 2 aperiodic CSI reports. In the field added to the DCI, for each CSI report, 1 bit is used to indicate contents of the CSI report.
0: indicates that the contents of the CSI report contain feeding back the true CSI, the CSI generated based on AI/ML and the CSI generated based on codebooks;
1: maintain existing contents of the CSI report, which may be any one of true CSI, CSI generated based on AI/ML and CSI generated based on codebooks.

A type and parameters of the used codebook are determined by the CSI report configuration, that is, information on available codebooks is included in the CSI report configuration.

That is, 8 bits are used to indicate methods for generating CSI used by the 8 CSI reports. Methods for generating CSI of all CSI reports may be denoted in a bitmap manner. For example, (0, 1, 1, 1, 0, 0, 0, 1) denote that CSI reports 0, 4, 5, 6 report the true CSI, the CSI generated based on AI/ML, and the CSI generated based on codebooks, and CSI reports 2, 3, 4, and 7 maintain existing contents of the CSI reports.

### Embodiment 4

In embodiment 4, the network device transmits DCI to the terminal equipment to indicate ON of AI/ML-based CSI feedback and/or OFF of feedback of the true CSI, and/or the CSI generated based on AI/ML, and/or the CSI generated based on codebooks. In embodiment 1, the CSI-ReportConfig information element has been expanded, and feedback of the true CSI is supported.

Similar to embodiment 2, 2 bits and bitmaps are used to indicate that all CSI reports under a CSI report configuration feed back the true CSI, the CSI generated based on AI/ML and the CSI generated based on codebooks.

In some implementations, a field is added to the DCI to indicate contents of all CSI reports under a CSI report configuration. The CSI of the CSI reports may include precoding matrix information and/or CQI, and uses 2 bits to describe the contents of all the CSI reports. For example, the bits are:
00: indicates that precoding matrix information of all the CSI reports is generated in the AI/ML method, and at the same time, the method for generating CSI based on codebooks and/or reporting the true CSI is/are closed;
01: indicates that the AI/ML method and/or reporting the true CSI is/are closed, and the precoding matrix information of all the CSI reports is generated in the codebook method;
10: indicates that the contents of all the CSI reports contain feeding back the true CSI, the CSI generated based on AI/ML and the CSI generated based on codebooks;
11: indicates that the contents of all the CSI reports contain feeding back the true CSI and the CSI generated based on AI/ML.

A type and parameters of the used codebook are determined by the CSI report configuration, that is, information on available codebooks is included in the CSI report configuration.

In some implementations, a field is added to the DCI to indicate contents of all CSI reports under a CSI report configuration. For each CSI report, it uses 2 bits to describe the contents of the CSI report. For example, a CSI report configuration contains 8 CSI reports, including 2 periodic CSI reports, 1 semi-persistent CSI report reported on a PUCCH, 3 semi-persistent CSI reports reported on a PUSCH, and 2 aperiodic CSI reports. In the field added to the DCI, for each CSI report, 2 bits are used to indicate contents of the CSI report.
00: indicates that precoding matrix information of the CSI report is generated in the AI/ML method, and at the same time, the method for generating CSI based on codebooks and/or reporting the true CSI is/are closed;
01: indicates that the AI/ML method and/or reporting the true CSI is/are closed, and the precoding matrix information of the CSI report is generated in the codebook method;
10: indicates that the contents of the CSI report contain feeding back the true CSI, the CSI generated based on AI/ML and the CSI generated based on codebooks;
11: indicates that the contents of the CSI report contain feeding back the true CSI and the CSI generated based on AI/ML.

A type and parameters of the used codebook are determined by the CSI report configuration, that is, information on available codebooks is included in the CSI report configuration.

That is, 8 bits are used to indicate methods for generating CSI used by the 8 CSI reports. Methods for generating CSI of all CSI reports may be denoted in a bitmap manner. For example, (0, 1, 1, 1, 0, 0, 0, 1) denote that CSI reports 0, 4, 5, 6 report the true CSI, the CSI generated based on AI/ML, and the CSI generated based on codebooks, and CSI reports 2, 3, 4, and 7 maintain existing contents of the CSI reports.

### Embodiment 5

In embodiment 5, an embodiment of monitoring of AI/ML performance of an aperiodic CSI report and subsequent actions after performance monitoring is given, including backoff from the method for generating CSI based on AI/ML to the method for generating CSI based on codebooks, and recovery from the method for generating CSI based on codebooks to the method for generating CSI based on AI/ML.

The aperiodic CSI report is configured by the first CSI report configuration given by the first RRC message. The CSI report is carried on a PUSCH. For example, there are two CSI reports, one of which containing the true CSI and the CSI generated based on AI/ML, and the other CSI report containing the CSI generated based on codebooks.

Step 1: indicating the terminal equipment by the network device to report the true CSI, the CSI generated based on AI/ML and the CSI generated based on codebooks. In some implementations, the first CSI report configuration given by the first RRC message includes only the CSI generated based on AI/ML. The network device transmits a second RRC message to the terminal equipment, the second RRC message configuring CSI triggering states for the terminal equipment, each triggering state corresponding to two CSI reports, denoted as a 0.1-th CSI report configuration and a 0.2-th CSI report configuration. The CSI resource configurations with which the two CSI reports are associated are identical (i.e. the two CSI reports under the two CSI report configurations are generated by identical CSI-RSs). In the 0.1-th CSI report configuration and the 0.2-th CSI report configuration, the terminal equipment is respectively configured to transmit {the true CSI, the CSI generated based on AI/ML} and {the CSI generated based on codebooks} to the network device. A configuration related to the CSI generated based on AI/ML in the 0.1-th CSI report configuration and a configuration related to the first CSI report configuration are identical. Specific implementations are given in subsections 3.1.1.1 and 3.3.1.2, and the field added to the CSI report configuration is given in subsection 3.3.1.

Step 2: monitoring performance of a first AI/ML model by the network device based on one or more of the following sets: {{a CSI report containing the true CSI, a CSI report containing the CSI generated based on AI/ML}, {a CSI report containing the CSI generated based on codebooks}}.

Step 3: making a decision by the network device according to a result of monitoring the performance of the first AI/ML model. A first possibility is that the network device decides to turn an AI/ML-based CSI feedback method back to a codebook-based CSI feedback method. In some implementations, the network device configures a second CSI report configuration by transmitting a third RRC message, so as to indicate the terminal equipment to use the codebook-based CSI feedback. The second CSI report configuration includes a codebook configuration (one of codebookConfig, codebookConfig-r16, codebookConfig-r17). The codebook configuration in the second CSI report configuration may be identical to or different from the codebook configuration in the 0.2-th CSI report configuration. A second possibility is that the network device decides to proceed with using the AI/ML-based method for generating CSI, that is, it does not turn an AI/ML-based CSI feedback method back to a codebook-based CSI feedback method. In some implementations, the network device configures a third CSI report configuration by transmitting an RRC message, so as to indicate the terminal equipment to use the AI/ML-based CSI feedback. A configuration regarding AI/ML in the third CSI report configuration is identical to a configuration regarding AI/ML in the first CSI report configuration.

Step 4: obtaining the second AI/ML model by the terminal equipment and the network device. The network device monitors performance of the second AI/ML model based on one or more of the following sets: {{a CSI report containing the true CSI, a CSI report containing the CSI generated based on AI/ML}, {a CSI report containing the CSI generated based on codebooks}}.

Step 5: indicating the terminal equipment by the network device to report the true CSI, the CSI generated based on AI/ML and the CSI generated based on codebooks (similar to step 2). In some implementations, the second CSI report configuration given by the third RRC message includes only the CSI generated based on codebooks. The network device transmits a fourth RRC message to the terminal equipment, the fourth RRC message configuring CSI triggering states for the terminal equipment, each triggering state corresponding to a 4.1-th CSI report configuration and a 4.2-th CSI report configuration. In the 4.1-th CSI report configuration and the 4.2-th CSI report configuration, the terminal equipment is configured to transmit {the true CSI, the AI/ML generated CSI} and {the CSI generated based on codebooks} respectively to the network device. A relevant configuration of the CSI generated based on codebooks in the 4.2-th CSI report configuration is identical to a relevant configuration in the second CSI report configuration. Specific implementations are given in embodiment 1 and embodiment 2, and the field added to the CSI report configuration is given in embodiment 1.

Step 6: making a decision by the network device according to a result of monitoring the performance of the second AI/ML model. A first possibility is that the network device decides to turn a codebook-based CSI feedback method back to an AI/ML-based CSI feedback method. In some implementations, the network device configures a fifth CSI report configuration by transmitting an RRC message, so as to indicate the terminal equipment to use the AI/ML-based CSI feedback. The AI/ML configuration in the fifth CSI report configuration may be identical to the AI/ML configuration in the 4.1-th CSI report configuration. A second possibility is that the network device decides to proceed with using the codebook-based method for generating CSI, that is, it does not turn a codebook-based CSI feedback method back to an AI/ML-based CSI feedback method. In some implementations, the network device configures a sixth CSI report configuration by transmitting an RRC message, so as to indicate the terminal equipment to use the codebook-based CSI feedback. The sixth CSI report configuration includes a codebook configuration (one of codebookConfig, codebookConfig-r16 and codebookConfig-r17), which is identical to relevant configuration in the second CSI report configuration and/or the 4.2-th report configuration.

### Embodiment 6

In the embodiment of the sixth aspect, an embodiment of monitoring of AI/ML performance of an aperiodic CSI report and subsequent actions after performance monitoring is given, including backoff from the method for generating CSI based on AI/ML to the method for generating CSI based on codebooks, and recovery from the method for generating CSI based on codebooks to the method for generating CSI based on AI/ML. The aperiodic CSI report is configured by the first CSI report configuration given by the first RRC message. The CSI report is carried on a PUSCH. For example, there are two CSI reports, one of which containing the true CSI and the CSI generated based on AI/ML, and the other CSI report containing the CSI generated based on codebooks.

Step 1: indicating the terminal equipment by the network device to report the true CSI, the CSI generated based on AI/ML and the CSI generated based on codebooks. In some implementations, the first CSI report configuration given by the first RRC message includes only the CSI generated based on AI/ML. The network device transmits a second RRC message to the terminal equipment, the second RRC message configuring CSI triggering states for the terminal equipment, each triggering state corresponding to two CSI reports, denoted as a 0.1-th CSI report configuration and a 0.2-th CSI report configuration. The CSI resource configurations with which the two CSI reports are associated are identical. That is, the two CSI reports under the two CSI report configurations are generated by identical CSI-RSs. In the 0.1-th CSI report configuration and the 0.2-th CSI report configuration, the terminal equipment is respectively configured to transmit {the true CSI, the CSI generated based on AI/ML} and {the CSI generated based on codebooks} to the network device. A configuration related to the CSI generated based on AI/ML in the 0.1-th CSI report configuration and a configuration related to the first CSI report configuration are identical. Specific implementations are given in subsections 3.3.1.1 and 3.3.1.2, and the field added to the CSI report configuration is given in subsection 3.3.1.

Step 2: monitoring performance of a first AI/ML model by the network device based on one or more of the following sets: {{a CSI report containing the true CSI, a CSI report containing the CSI generated based on AI/ML}, {a CSI report containing the CSI generated based on codebooks}}.

Step 3: making a decision by the network device according to a result of monitoring the performance of the first AI/ML model. A first possibility is that the network device decides to turn an AI/ML-based CSI feedback method back to a codebook-based CSI feedback method. In some implementations, the network device triggers the CSI generated based on codebooks in the 0.2-th report configuration via an MAC CE together with DCI signaling. A second possibility is that the network device decides to proceed with using the AI/ML-based method for generating CSI, that is, it does not turn an AI/ML-based CSI feedback method back to a codebook-based CSI feedback method. In some implementations, the network device triggers the CSI generated based on AI/ML in the 0.1-th report configuration via an MAC CE together with first DCI signaling, and indicates via second DCI signaling and/or second MAC CE signaling that the 0.1-th report configuration includes only the CSI generated based on AI/ML. A specific implementation is given in subsections 3.3.2 and 3.3.4.

Step 4: obtaining the second AI/ML model by the terminal equipment and the network device. The network device monitors performance of the second AI/ML model based on one or more of the following sets: {{a CSI report containing the true CSI, a CSI report containing the CSI generated based on AI/ML}, {a CSI report containing the CSI generated based on codebooks}}.

Step 5: indicating the terminal equipment by the network device to report the true CSI, the CSI generated based on AI/ML and the CSI generated based on codebooks (similar to step 2). In some implementations, the network device triggers the 0.1-th report configuration and the 0.2-th report configuration via an MAC CE together with DCI signaling, that is, the network device is triggered to transmit a CSI-RS to the terminal equipment, and the terminal equipment transmits the true CSI, the AI/ML generated CSI and the CSI generated based on codebooks to the network device.

Step 6: making a decision by the network device according to a result of monitoring the performance of the second AI/ML model. A first possibility is that the network device decides to turn a codebook-based CSI feedback method back to an AI/ML-based CSI feedback method. In some implementations, the network device triggers the CSI generated based on AI/ML in the 0.1-th report configuration via an MAC CE together with first DCI signaling, and indicates via a first MAC CE together with the first DCI signaling, and indicates via the second DCI signaling and/or second MAC CE signaling that the 0.1-th report configuration includes only the CSI generated based on AI/ML. A second possibility is that the network device decides to proceed with using the codebook-based method for generating CSI, that is, it does not turn a codebook-based CSI feedback method back to an AI/ML-based CSI feedback method. In some implementations, the network device triggers the CSI generated based on codebooks in the 0.2-th report configuration via an MAC CE together with DCI signaling.

### Embodiment 7

In embodiment 7, an embodiment of monitoring of performance of a first AI/ML model of a semi-persistent CSI report and subsequent actions after performance monitoring is given, including backoff from the method for generating CSI based on AI/ML to the method for generating CSI based on codebooks, and recovery from the method for generating CSI based on codebooks to the method for generating CSI based on AI/ML. The semi-persistent CSI report is configured by the first CSI report configuration given by the first RRC message. The CSI report is carried on a PUSCH or a PUCCH. For example, a CSI report includes three types of CSI.

Step 1: indicating the terminal equipment by the network device to report the true CSI, the CSI generated based on AI/ML and the CSI generated based on codebooks. In some implementations, the first CSI report configuration given by the first RRC message includes only the CSI generated based on AI/ML. The network device transmits a second RRC message to the terminal equipment, the second RRC message configuring CSI triggering states for the terminal equipment, each triggering state corresponding to a 0-th CSI report configuration. In the 0-th CSI report configuration, the terminal equipment is configured to transmit the true CSI, the CSI generated based on AI/ML and the CSI generated based on codebooks to the network device. A configuration related to the CSI generated based on AI/ML in the 0-th CSI report configuration and a configuration related to the first CSI report configuration are identical. Specific implementations are given in the previous embodiments, and the field added to the CSI report configuration is given in the previous embodiments.

Step 2: monitoring performance of a first AI/ML model by the network device based on one or more CSI reports containing the true CSI, the CSI generated based on AI/ML and the CSI generated based on codebooks.

Step 3: making a decision by the network device according to a result of monitoring the performance of the first AI/ML model. A first possibility is that the network device decides to turn an AI/ML-based CSI feedback method back to a codebook-based CSI feedback method. In some implementations, the network device configures a second CSI report configuration by transmitting a third RRC message, so as to indicate the terminal equipment to use CSI feedback based on codebooks. The second CSI report configuration includes a codebook configuration (one of codebookConfig, codebookConfig-r16 and codebookConfig-r17). A codebook configuration in the second CSI report configuration may be identical to or different from a codebook configuration in the 0-th CSI report configuration. A second possibility is that the network device decides to proceed with using the AI/ML-based method for generating CSI, that is, it does not turn an AI/ML-based CSI feedback method back to a codebook-based CSI feedback method. In some implementations, the network device configures a third CSI report configuration by transmitting an RRC message, so as to indicate the terminal equipment to use CSI feedback based on AI/ML. An AI/ML configuration in the third CSI report configuration may be identical to an AI/ML configuration in the first CSI report configuration.

Step 4: obtaining the second AI/ML model by the terminal equipment and the network device. The network device monitors performance of the second AI/ML model based on one or more CSI reports containing the true CSI, the CSI generated based on AI/ML and the CSI generated based on codebooks.

Step 5: indicating the terminal equipment by the network device to report the true CSI, the CSI generated based on AI/ML and the CSI generated based on codebooks (similar to step 2). In some implementations, the second CSI report configuration given by the third RRC message includes only the CSI generated based on codebooks. The network device transmits a fourth RRC message to the terminal equipment, the fourth RRC message configuring CSI triggering states for the terminal equipment, each triggering state corresponding to a fourth CSI report configuration. In the fourth CSI report configuration, the terminal equipment is configured to transmit the true CSI, the CSI generated based on AI/ML and the CSI generated based on codebooks to the network device. A configuration related to the CSI generated based on codebooks in the fourth CSI report configuration and a configuration related to the second CSI report configuration are identical. Specific implementations are given in subsection 3.3.1.1, and the field added to the CSI report configuration is given in subsection 3.3.1.

Step 6: making a decision by the network device according to a result of monitoring the performance of the second AI/ML model. A first possibility is that the network device decides to turn a codebook-based CSI feedback method back to an AI/ML-based CSI feedback method. In some implementations, the network device configures a fifth CSI report configuration by transmitting an RRC message, so as to indicate the terminal equipment to use CSI feedback based on AI/ML. An AI/ML configuration in the fifth CSI report configuration may be identical to an AI/ML configuration in the fourth CSI report configuration. A second possibility is that the network device decides to proceed with using the codebook-based method for generating CSI, that is, it does not turn a codebook-based CSI feedback method back to an AI/ML-based CSI feedback method. In some implementations, the network device configures a sixth CSI report configuration by transmitting an RRC message, so as to indicate the terminal equipment to use CSI feedback based on codebooks. The sixth CSI report configuration includes a codebook configuration (one of codebookConfig, codebookConfig-r16 and codebookConfig-r17), which is identical to a relevant configuration in the second CSI report configuration.

### Embodiment 8

In embodiment 8, an embodiment of monitoring of performance of a first AI/ML model of a semi-persistent CSI report and subsequent actions after performance monitoring is given, including backoff from the method for generating CSI based on AI/ML to the method for generating CSI based on codebooks, and recovery from the method for generating CSI based on codebooks to the method for generating CSI based on AI/ML. The semi-persistent CSI report is configured by the first CSI report configuration given by the first RRC message. The CSI report is carried on a physical uplink shared channel (PUSCH) or a physical uplink control channel (PUCCH). In this embodiment, a CSI report includes three types of CSI, a CSI report configured by RRC is kept unchanged, and realization of a function of indicating the terminal equipment to transmit the three types of CSI is indicated via DCI signaling or MAC CE signaling.

Before the following steps are executed, via MAC CE signaling, the network device deactivates a semi-persistent CSI report of the CSI generated based on AI/ML that needs monitoring of AI/ML performance.

Step 1: indicating the terminal equipment by the network device to report the true CSI, the CSI generated based on AI/ML and the CSI generated based on codebooks. In some implementations, the first CSI report configuration given by the first RRC message includes configuration information of the true CSI, the CSI generated based on AI/ML and the CSI generated based on codebooks, but only the CSI generated based on AI/ML is activated. In this implementation, the network device indicates via DCI signaling that the CSI report includes the true CSI, the CSI generated based on AI/ML and the CSI generated based on codebooks. Four specific implementations are given in embodiment 3 and embodiment 4. In some implementations, via MAC CE signaling, the network device may activate the CSI report including the true CSI, the CSI generated based on AI/ML and the CSI generated based on codebooks.

Step 2: monitoring performance of a first AI/ML model by the network device based on one or more CSI reports containing the true CSI, the CSI generated based on AI/ML and the CSI generated based on codebooks.

Step 3: making a decision by the network device according to a result of monitoring the performance of the first AI/ML model. A first possibility is that the network device decides to turn an AI/ML-based CSI feedback method back to a codebook-based CSI feedback method. In some implementations, (still in the first CSI report configuration configured by the first RRC message,) the network device indicates via DCI signaling that the CSI report includes only the CSI generated based on codebooks. Four specific implementations are given in subsections 3.3.2 and 3.3.4. In some implementations, (still in the first CSI report configuration configured by the first RRC message,) the network device indicates via MAC CE signaling that the CSI report includes only the CSI generated based on codebooks. A second possibility is that the network device decides to proceed with using the AI/ML-based method for generating CSI, that is, it does not turn an AI/ML-based CSI feedback method to back to a codebook-based CSI feedback method. In some implementations, (still in the first CSI report configuration configured by the first RRC message,) the network device indicates via DCI signaling that the CSI report includes only the CSI generated based on AI/ML. Four specific implementations are given in subsections 3.3.2 and 3.3.4. In some implementations, (still in the first CSI report configuration configured by the first RRC message,) the network device indicates via MAC CE signaling that the CSI report includes only the CSI generated based on AI/ML.

Step 4: obtaining a second AI/ML model by the terminal equipment and the network device. The network device monitors performance of the second AI/ML model based on one or more CSI reports containing the true CSI, the CSI generated based on AI/ML and the CSI generated based on codebooks.

Step 5: indicating the terminal equipment by the network device to report the true CSI, the CSI generated based on AI/ML and the CSI generated based on codebooks (similar to step 2). In some implementations, the first CSI report configuration given by the first RRC message includes configuration information of the true CSI, the CSI generated based on AI/ML and the CSI generated based on codebooks, but only the CSI generated based on codebooks is activated. In this implementation, the network device indicates via DCI signaling that the CSI report includes the true CSI, the CSI generated based on AI/ML and the CSI generated based on codebooks. Four specific implementations are given in subsections 3.3.3 and 3.3.4. Via MAC CE signaling, the network device may activate the CSI report including the true CSI, the CSI generated based on AI/ML and the CSI generated based on codebooks.

Step 6: making a decision by the network device according to a result of monitoring the performance of the second AI/ML model. A first possibility is that the network device decides to turn a codebook-based CSI feedback method back to an AI/ML-based CSI feedback method. In some implementations, (still in the first CSI report configuration configured by the first RRC message,) the network device indicates via DCI signaling that the CSI report includes only the CSI generated based on AI/ML. Four specific implementations are given in subsections 3.3.2 and 3.3.4. In some implementations, (still in the first CSI report configuration configured by the first RRC message,) the network device indicates via MAC CE signaling that the CSI report includes only the CSI generated based on AI/ML. A second possibility is that the network device decides to proceed with using the codebook-based method for generating CSI, that is, it does not turn a codebook-based CSI feedback method back to an AI/ML-based CSI feedback method. In some implementations, (still in the first CSI report configuration configured by the first RRC message,) the network device indicates via DCI signaling that the CSI report includes only the CSI generated based on codebooks. Four specific implementations are given in subsections 3.3.2 and 3.3.4. In some implementations, (still in the first CSI report configuration configured by the first RRC message,) the network device indicates via MAC CE signaling that the CSI report includes only the CSI generated based on codebooks.

### Embodiment 9

In embodiment 9, an embodiment of monitoring of AI/ML performance of an aperiodic CSI report and subsequent actions after performance monitoring is given, including backoff from the method for generating CSI based on AI/ML to the method for generating CSI based on codebooks, and recovery from the method for generating CSI based on codebooks to the method for generating CSI based on AI/ML. The aperiodic CSI report is configured by the first CSI report configuration given by the first RRC message. The CSI report is carried on a PUSCH. In this embodiment, a CSI report includes three types of CSI, and a function of indicating the terminal equipment is achieved by changing a CSI report configuration configured by RRC.

Implementations of this embodiment are similar to those of embodiment 7, and shall not be repeated herein any further.

### Embodiment 10

In embodiment 10, an embodiment of monitoring of AI/ML performance of an aperiodic CSI report and subsequent actions after performance monitoring is given, including backoff from the method for generating CSI based on AI/ML to the method for generating CSI based on codebooks, and recovery from the method for generating CSI based on codebooks to the method for generating CSI based on AI/ML. The aperiodic CSI report is configured by the first CSI report configuration given by the first RRC message. The CSI report is carried on a PUSCH. In this embodiment, a CSI report includes three types of CSI, the CSI report configured by RRC is kept unchanged, and functions are achieved by indicating by DCI signaling or MAC CE signaling.

Implementations of this embodiment are similar to those of embodiment 8, and shall not be repeated herein any further.

### Embodiment 11

In embodiment 11, an embodiment of monitoring of AI/ML performance of an aperiodic CSI report and subsequent actions after performance monitoring is given, including backoff from the method for generating CSI based on AI/ML to the method for generating CSI based on codebooks, and recovery from the method for generating CSI based on codebooks to the method for generating CSI based on AI/ML. The aperiodic CSI report is configured by the first CSI report configuration given by the first RRC message. The CSI report is carried on a PUSCH. In this embodiment, the terminal equipment transmits three CSI reports, each CSI report including one type of CSI.

Step 1: indicating the terminal equipment by the network device to report the true CSI, the CSI generated based on AI/ML and the CSI generated based on codebook. In some implementations, the first CSI report configuration given by the first RRC message includes only the CSI generated based on AI/ML. The network device transmits a second RRC message to the terminal equipment, the second RRC message configuring CSI triggering states for the terminal equipment, each triggering state corresponding to three CSI reports, denoted as a 0.1-th CSI report configuration, a 0.2-th CSI report configuration and a 0.3-th CSI report configuration. CSI resource configurations with which the three CSI reports are associated are identical (i.e. the three CSI reports under the three CSI report configurations are generated by identical CSI-RS and/or CSI-RS resources). In the 0.1-th CSI report configuration, 0.2-th CSI report configuration and 0.3-th CSI report configuration, the terminal equipment is respectively configured to transmit the true CSI, the CSI generated based on AI/ML and the CSI generated based on codebooks to the network device. A relevant configuration of the CSI generated based on AI/ML in the 0.2-th CSI report configuration is identical to a relevant configuration in the first CSI report configuration. Specific implementations are given in embodiment 2, and the field added to the CSI report configuration is given in embodiment 1.

Step 2: monitoring the performance of the first AI/ML model by the network device based on one or more of the following sets: {a CSI report containing the true CSI, a CSI report containing the CSI generated based on AI/ML, and a CSI report containing the CSI generated based on codebooks.

Step 3: making a decision by the network device according to a result of monitoring the performance of the first AI/ML model. A first possibility is that the network device decides to turn an AI/ML-based CSI feedback method back to a codebook-based CSI feedback method. In some implementations, the network device configures a second CSI report configuration by transmitting a third RRC message, so as to indicate the terminal equipment to use the codebook-based CSI feedback. The second CSI report configuration includes a codebook configuration (one of codebookConfig, codebookConfig-r16, codebookConfig-r17). The codebook configuration in the second CSI report configuration may be identical to or different from the codebook configuration in the 0.3-th CSI report configuration. A second possibility is that the network device decides to proceed with using the AI/ML-based method for generating CSI, that is, it does not turn an AI/ML-based CSI feedback method back to a codebook-based CSI feedback method. In some implementations, the network device configures a third CSI report configuration by transmitting an RRC message, so as to indicate the terminal equipment to use the AI/ML-based CSI feedback. A configuration regarding AI/ML in the third CSI report configuration is identical to a configuration regarding AI/ML in the first CSI report configuration.

Step 4: obtaining the second AI/ML model by the terminal equipment and the network device. The network device monitors performance of the second AI/ML model based on one or more of the following sets: {a CSI report containing the true CSI, a CSI report containing the CSI generated based on AI/ML, and a CSI report containing the CSI generated based on codebooks}.

Step 5: indicating the terminal equipment by the network device to report the true CSI, the CSI generated based on AI/ML and the CSI generated based on codebooks (similar to step 2). In some implementations, the second CSI report configuration given by the third RRC message includes only the CSI generated based on codebooks. The network device transmits a fourth RRC message to the terminal equipment, the fourth RRC message configuring CSI triggering states for the terminal equipment, each triggering state corresponding to a 4.1-th CSI report configuration, a 4.2-th CSI report configuration, a 4.3-th CSI report configuration. In the 4.1-th CSI report configuration, the 4.2-th CSI report configuration and the 4.3-th CSI report configuration, the terminal equipment is configured to respectively transmit the true CSI, the CSI generated based on AI/ML and the CSI generated based on codebooks to the network device. A configuration related to the CSI generated based on codebooks in the 4.3-th CSI report configuration and a configuration related to the second CSI report configuration are identical. Specific implementations are given in embodiment 2, and the field added to the CSI report configuration is given in embodiment 1.

Step 6: making a decision by the network device according to a result of monitoring the performance of the second AI/ML model. A first possibility is that the network device decides to recover an AI/ML-based CSI feedback method from a codebook-based CSI feedback method. In some implementations, the network device configures a fifth CSI report configuration by transmitting an RRC message, so as to indicate the terminal equipment to use CSI feedback based on AI/ML. An AI/ML configuration in the fifth CSI report configuration may be identical to an AI/ML configuration in the 4.2-th CSI report configuration. A second possibility is that the network device decides to proceed with using the codebook-based method for generating CSI, that is, it does not recover an AI/ML-based CSI feedback method from a codebook-based CSI feedback method. In some implementations, the network device configures a sixth CSI report configuration by transmitting an RRC message, so as to indicate the terminal equipment to use CSI feedback based on codebooks. The sixth CSI report configuration includes a codebook configuration (one of codebookConfig, codebookConfig-r16 and codebookConfig-r17), which is identical to a relevant configuration in the second CSI report configuration and/or the 4.4-th CSI report configuration.

### Embodiment 12

In the of embodiment of the twelfth aspect, an embodiment of monitoring of AI/ML performance of an aperiodic CSI report and subsequent actions after performance monitoring is given, including backoff from the method for generating CSI based on AI/ML to the method for generating CSI based on codebooks, and recovery from the method for generating CSI based on codebooks to the method for generating CSI based on AI/ML. The aperiodic CSI report is configured by the first CSI report configuration given by the first RRC message. The CSI report is carried on a PUSCH. In this embodiment, the terminal equipment transmits three CSI reports, each CSI report including one type of CSI, and the CSI report configured by RRC is kept unchanged, and functions are achieved by indicating by DCI signaling or MAC CE signaling.

Step 1: indicating the terminal equipment by the network device to report the true CSI, the CSI generated based on AI/ML and the CSI generated based on codebook. In some implementations, the first CSI report configuration given by the first RRC message includes only the CSI generated based on AI/ML. The network device transmits a second RRC message to the terminal equipment, the second RRC message configuring CSI triggering states for the terminal equipment, each triggering state corresponding to three CSI reports, denoted as a 0.1-th CSI report configuration, a 0.2-th CSI report configuration and a 0.3-th CSI report configuration. CSI resource configurations with which the three CSI reports are associated are identical (i.e. the three CSI reports under the three CSI report configurations are generated by identical CSI-RS and/or CSI-RS resources). In the 0.1-th CSI report configuration, 0.2-th CSI report configuration and 0.3-th CSI report configuration, the terminal equipment is respectively configured to transmit the true CSI, the CSI generated based on AI/ML and the CSI generated based on codebooks to the network device. A relevant configuration of the CSI generated based on AI/ML in the 0.2-th CSI report configuration is identical to a relevant configuration in the first CSI report configuration. Specific implementations are given in embodiment 2, and the field added to the CSI report configuration is given in embodiment 1.

Step 2: monitoring the performance of the first AI/ML model by the network device based on one or more of the following sets: {a CSI report containing the true CSI, a CSI report containing the CSI generated based on AI/ML, and a CSI report containing the CSI generated based on codebooks.

Step 3: making a decision by the network device according to a result of monitoring the performance of the first AI/ML model. A first possibility is that the network device decides to turn an AI/ML-based CSI feedback method back to a codebook-based CSI feedback method. In some implementations, the network device triggers the CSI generated based on codebooks in the 0.3-th report configuration via an MAC CE together with DCI signaling. A second possibility is that the network device decides to proceed with using the AI/ML-based method for generating CSI, that is, it does not turn an AI/ML-based CSI feedback method back to a codebook-based CSI feedback method. In some implementations, the network device triggers the CSI generated based on AI/ML in the 0.2-th report configuration via an MAC CE together with first DCI signaling.

Step 4: obtaining the second AI/ML model by the terminal equipment and the network device. The network device monitors performance of the second AI/ML model based on one or more of the following sets: {a CSI report containing the true CSI, a CSI report containing the CSI generated based on AI/ML, and a CSI report containing the CSI generated based on codebooks}.

Step 5: indicating the terminal equipment by the network device to report the true CSI, the CSI generated based on AI/ML and the CSI generated based on codebooks (similar to step 2). In some implementations, the network device triggers the 0.1-th report configuration, the 0.2-th report configuration and the 0.3-th report configuration via an MAC CE together with DCI signaling, that is, the network device is triggered to transmit a CSI-RS to the terminal equipment, and the terminal equipment transmits the true CSI, the AI/ML generated CSI and the CSI generated based on codebooks to the network device.

Step 6: making a decision by the network device according to a result of monitoring the performance of the second AI/ML model. A first possibility is that the network device decides to recover an AI/ML-based CSI feedback method from a codebook-based CSI feedback method. In some implementations, the network device triggers the CSI generated based on AI/ML in the 0.2-th report configuration via an MAC CE together with first DCI signaling. A second possibility is that the network device decides to proceed with using the codebook-based method for generating CSI, that is, it does not recover a codebook-based CSI feedback method from an AI/ML-based CSI feedback method. In some implementations, the network device triggers the CSI generated based on codebooks in the 0.3-th report configuration via an MAC CE together with DCI signaling.

### Embodiment 13

In embodiment 13, an embodiment of monitoring of performance of a first AI/ML model of a semi-persistent CSI report and subsequent actions after performance monitoring is given, including switching from the method for generating CSI based on AI/ML to the method for generating CSI based on codebooks, and switching from the method for generating CSI based on codebooks to the method for generating CSI based on AI/ML. The semi-persistent CSI report is configured by the first CSI report configuration given by the first RRC message. The CSI report is carried on a PUSCH or a PUCCH. In this embodiment, a CSI report includes two types of CSI, and functions are achieved by changing the CSI report configuration configured by RRC.

Step 1: indicating the terminal equipment by the network device to report the true CSI and the CSI generated based on AI/ML. In some implementations, the first CSI report configuration given by the first RRC message includes only the CSI generated based on AI/ML. The network device transmits a second RRC message to the terminal equipment, the second RRC message configuring CSI triggering states for the terminal equipment, each triggering state corresponding to a 0-th CSI report configuration. In the 0-th CSI report configuration, the terminal equipment is configured to transmit the true CSI and the CSI generated based on AI/ML to the network device. A relevant configuration of the CSI generated based on AI/ML in the 0-th CSI report configuration is identical to a relevant configuration in the first CSI report configuration. Specific implementations are given in subsection 3.3.1.1, and the field added to the CSI report configuration is given in 3.3.1.

Step 2: monitoring the performance of the first AI/ML model by the network device based on one or more CSI reports containing the true CSI and the CSI generated based on AI/ML. One example is that a critical value is configured by the network device or specified in standards. The critical value is compared with a KPI for model performance monitoring. Based on a size relationship between the two, whether to switch to reporting CSI based on a codebook method or continue generating CSI based on an AI/ML model is determined. For example, the KPI is a generalized cosine similarity (GCS) or a square of generalized cosine similarity (SGCS), and the critical value is a GCS or SGCS specified by one or more standards or configured by the network device. The given critical value may be related to a CSI configuration and CSI report, such as a bitwidth of at least a part of the CSI. For example, the larger the bitwidth of at least a part of the CSI, the larger the critical value, and the smaller the bitwidth of at least a part of the CSI, the smaller the critical value. The critical value may also be related to a communication scenario.
When SGCSs of the true CSI and the CSI generated based on the first AI/ML are greater than or equal to the critical value, the network device deems that the performance of the used first AI/ML model is good enough and proceeds with using the CSI feedback based on the first AI/ML;
When SGCSs of the true CSI and the CSI generated based on the first AI/ML are less than the critical value, the network device deems that the performance of the used first AI/ML model is not good enough and switches to the codebook-based CSI feedback.

For the same bitwidth, there may also be multiple critical values. For example, a critical value 1 is less than a critical value 2.
When SGCSs of the true CSI and the CSI generated based on the first AI/ML are greater than the critical value 2, the network device deems that the performance of the used first AI/ML model is good enough and proceeds with using the CSI feedback based on the first AI/ML;
When SGCSs of the true CSI and the CSI generated based on the first AI/ML are greater than the critical value 1 and less than the critical value 2, the network device proceeds with using the AI/ML-based model to feed back CSI, but it needs to replace the first AI/ML with a fifth AI/ML, so that SGCSs of the true CSI and CSI generated based on the fifth AI/ML are greater than the critical value 2;
When SGCSs of the true CSI and the CSI generated based on the first AI/ML are less than the critical value 1, it switches to the codebook-based CSI feedback.

Step 3: making a decision by the network device according to a result of monitoring the performance of the first AI/ML model. A first possibility is that the network device decides to turn an AI/ML-based CSI feedback method back to a codebook-based CSI feedback method. In some implementations, the network device configures a second CSI report configuration by transmitting a third RRC message, so as to indicate the terminal equipment to use the codebook-based CSI feedback. The second CSI report configuration includes a codebook configuration (one of codebookConfig, codebookConfig-r16, codebookConfig-r17). A second possibility is that the network device decides to proceed with using the AI/ML-based method for generating CSI, that is, it does not turn an AI/ML-based CSI feedback method back to a codebook-based CSI feedback method. In some implementations, the network device configures a third CSI report configuration by transmitting an RRC message, so as to indicate the terminal equipment to use the AI/ML-based CSI feedback. A configuration regarding AI/ML in the third CSI report configuration is identical to a configuration regarding AI/ML in the first CSI report configuration.

Step 4: obtaining the second AI/ML model by the terminal equipment and the network device. The network device monitors performance of the second AI/ML model based on one or more CSI reports containing the true CSI and the CSI generated based on AI/ML (similar to step 2).

Step 5: indicating the terminal equipment by the network device to report the true CSI and the CSI generated based on AI/ML (similar to step 1). In some implementations, the network device transmits a fourth RRC message to the terminal equipment, the fourth RRC message configuring CSI triggering states for the terminal equipment, each triggering state corresponding to a fourth CSI report configuration. In the fourth CSI report configuration, the terminal equipment is configured to transmit the true CSI and the CSI generated based on AI/ML to the network device. Specific implementations are given in 3.3.1.1, and the field added to the CSI report configuration is given in 3.3.1.

Step 6: making a decision by the network device according to a result of monitoring the performance of the second AI/ML model. A first possibility is that the network device decides to recover an AI/ML-based CSI feedback method from a codebook-based CSI feedback method. In some implementations, the network device configures a fifth CSI report configuration by transmitting an RRC message, so as to indicate the terminal equipment to use CSI feedback based on AI/ML. An AI/ML configuration in the fifth CSI report configuration may be identical to an AI/ML configuration in the fourth CSI report configuration. A second possibility is that the network device decides to proceed with using the codebook-based method for generating CSI, that is, it does not recover an AI/ML-based CSI feedback method from a codebook-based CSI feedback method. In some implementations, the network device configures a sixth CSI report configuration by transmitting an RRC message, so as to indicate the terminal equipment to use CSI feedback based on codebooks. The sixth CSI report configuration includes a codebook configuration (one of codebookConfig, codebookConfig-r16 and codebookConfig-r17), which is identical to a relevant configuration in the second CSI report configuration.

### Embodiment 14

In embodiment 14, for the case where the terminal equipment reports both the true CSI and the CSI generated based on AI/ML, the case of aperiodic CSI reports may be traversed. The manner of indicating by the DCI and/or the MAC CE without changing RRC configuration may be traversed, which is similar to embodiments 8, and shall not be repeated herein any further.

### Embodiment 15

Embodiment 15 is similar to embodiment 13, with a difference of the second step, and identical parts shall not be described herein any further. The second step of embodiment 15 shall be described below.

Step 2: monitoring the performance of the first AI/ML model by the network device based on one or more CSI reports containing the true CSI and the CSI generated based on AI/ML. One example is that a critical value is configured by the network device or specified in standards. The critical value is compared with a KPI for model performance monitoring. Based on a size relationship between the two, whether to switch to reporting CSI based on a codebook method or continue generating CSI based on an AI/ML model is determined. For example, the KPI is a generalized cosine similarity (GCS) or a square of generalized cosine similarity (SGCS), and the critical value is a GCS or SGCS specified by one or more standards or configured by the network device. The given critical value may be related to a CSI configuration and CSI report, such as a bitwidth of at least a part of the CSI. For example, the larger the bitwidth of at least a part of the CSI, the larger the critical value, and the smaller the bitwidth of at least a part of the CSI, the smaller the critical value.
When SGCSs of the true CSI and the CSI generated based on the first AI/ML are greater than or equal to the critical value, the network device deems that the performance of the used first AI/ML model is good enough and proceeds with using the CSI feedback based on the first AI/ML;
When SGCSs of the true CSI and the CSI generated based on the first AI/ML are less than the critical value, the network device transmits configuration information to the terminal equipment, indicating the terminal equipment to transmit the true CSI, the CSI generated based on AI/ML and the CSI generated based on codebooks.

When the SGCSs of the true CSI and the CSI generated based on the first AI/ML are greater than the SGCSs of the true CSI and the CSI generated based on codebooks, it proceeds with using the CSI feedback based on the first AI/ML; otherwise, it uses the codebook-based CSI feedback.

For the same bitwidth, there may also be multiple critical values. For example, a critical value 1 is less than a critical value 2.

When SGCSs of the true CSI and the CSI generated based on the first AI/ML are greater than the critical value 2, the network device deems that the performance of the used first AI/ML model is good enough and proceeds with using the CSI feedback based on the first AI/ML;

When SGCSs of the true CSI and the CSI generated based on the first AI/ML are greater than the critical value 1 and less than the critical value 2, in some implementations, the network device transmits configuration information to the terminal equipment to indicate the terminal equipment to transmit the true CSI, the CSI generated based on AI/ML and the CSI generated based on codebooks. When the SGCSs of the true CSI and the CSI generated based on the first AI/ML are greater than the SGCSs of the true CSI and the CSI generated based on codebooks, it proceeds with using the CSI feedback based on the first AI/ML; otherwise, it uses the codebook-based CSI feedback. In some implementations, the network device calculates the CSI generated based on codebooks according to the true CSI and a tenth codebook configuration selected by the network device, and a bitwidth of the CSI generated based on codebooks is similar to that of the CSI generated based on the first AI/ML (similar definitions are given in the highlighted blue on page 4, subsection 3.3). The network device calculates the SGCS of the true CSI and the CSI generated based on the first AI/ML, denoted as SGCS1, and SGCS of the true CSI and the CSI generated based on codebooks, denoted as SGCS2. When SGCS1 is greater than SGCS2, it proceeds with using the CSI feedback based on the first AI/ML; otherwise, it uses the codebook-based CSI feedback, and the codebook configuration is the tenth codebook configuration.

When SGCSs of the true CSI and the CSI generated based on the first AI/ML are less than the critical value 1, it switches to the codebook-based CSI feedback.

### Embodiment 16

In embodiment 16, for the case where the terminal equipment reports both the true CSI and the CSI generated based on AI/ML, the case of aperiodic CSI reports may be traversed. The manner of indicating by the DCI and/or the MAC CE without changing RRC configuration may be traversed, which is similar to embodiment 8, and shall not be repeated herein any further.

### Embodiment 17

In embodiment 17, an embodiment of monitoring of performance of a first AI/ML model of a semi-persistent CSI report and subsequent actions after performance monitoring is given, including switching from the method for generating CSI based on AI/ML to the method for generating CSI based on codebooks, and switching from the method for generating CSI based on codebooks to the method for generating CSI based on AI/ML. The semi-persistent CSI report is configured by the first CSI report configuration given by the first RRC message. The CSI report is carried on a PUSCH or a PUCCH. In this embodiment, a CSI report includes two types of CSI, and functions are achieved by changing the CSI report configuration configured by RRC.

A precoding vector in the true CSI is denoted as a first vector, which may be a right singular vector of the channel matrix or a vector obtained by performing scalar quantization on each element in the right singular vector. A vector corresponding to the PMI in the CSI generated based on codebooks is denoted as a second vector.

Step 1: indicating the terminal equipment by the network device to report the true CSI, the CSI generated based on AI/ML and generalized cosine similarities (GCSs) and/or squares of generalized cosine similarities (SGCSs) and/or normalized mean square errors (NMSEs) of the first vector and the second vector. In some implementations, the first CSI report configuration given by the first RRC message includes only the CSI generated based on AI/ML. The network device transmits a second RRC message to the terminal equipment, the second RRC message configuring CSI triggering states for the terminal equipment, each triggering state corresponding to a 0-th CSI report configuration. In the 0-th CSI report configuration, the terminal equipment is configured to transmit the true CSI, the CSI generated based on AI/ML and the GCSs and/or SGCSs and/or NMSEs of the first vector and the second vector to the network device. The 0-th CSI report configuration further includes a first codebook configuration, but the network device does not require the terminal equipment to report the CSI generated based on codebooks. One implementation is to configure a value of a report quantity corresponding to the method for generating CSI based on codebooks to be “none”, and configure a value of a report quantity corresponding to the method for generating CSI based on AI/ML and the method of the true CSI to be a value that is not “none”. A relevant configuration of the CSI generated based on AI/ML in the 0-th CSI report configuration is identical to a relevant configuration in the first CSI report configuration. A method for denoting the GCS and/or SGCS and/or NMSE in the 0-th CSI report configuration may be one of a single-precision floating-point number, a double-precision floating-point number, and an integral number, such as float32, and float64, etc. Specific implementations are given in subsection 3.3.1.1, and the field added to the CSI report configuration is given in subsection 3.3.1.

Step 2: monitoring performance of the first AI/ML model by the network device based on one or more CSI reports containing the true CSI, the CSI generated based on AI/ML and the GCS and/or SGCS and/or NMSE of the first vector and the second vector. One example is taking the GCS and/or SGCS and/or NMSE of the first vector and the second vector as a critical value, comparing the critical value with a KPI for model performance monitoring, and according to a size relationship between the two, determining to switch to reporting CSI based on the codebook method or continue generating CSI based on the AI/ML model. Taking the SGCS as an example:
When SGCSs of the true CSI and the CSI generated based on the first AI/ML are greater than or equal to the critical value, the network device deems that the performance of the used first AI/ML model is good enough and proceeds with using the CSI feedback based on the first AI/ML;
When SGCSs of the true CSI and the CSI generated based on the first AI/ML are less than the critical value, the network device deems that the performance of the used first AI/ML model is not good enough and switches to the codebook-based CSI feedback.

Step 3: making a decision by the network device according to a result of monitoring the performance of the first AI/ML model. A first possibility is that the network device decides to switch an AI/ML-based CSI feedback method to a codebook-based CSI feedback method. In some implementations, the network device configures a second CSI report configuration by transmitting a third RRC message, so as to indicate the terminal equipment to use the codebook-based CSI feedback. A codebook configuration included in the second CSI report configuration is identical to the first codebook configuration. A second possibility is that the network device decides to proceed with using the AI/ML-based method for generating CSI, that is, it does not switch an AI/ML-based CSI feedback method to a codebook-based CSI feedback method. In some implementations, the network device configures a third CSI report configuration by transmitting an RRC message, so as to indicate the terminal equipment to use the AI/ML-based CSI feedback. A configuration regarding AI/ML in the third CSI report configuration is identical to a configuration regarding AI/ML in the first CSI report configuration.

Step 4: obtaining the second AI/ML model by the terminal equipment and the network device. The network device monitors performance of the second AI/ML model based on one or more CSI reports containing the true CSI, the CSI generated based on AI/ML and the GCS and/or SGCS and/or NMSE of the first vector and the second vector (similar to step 2).

Step 5: indicating the terminal equipment by the network device to report the true CSI, the CSI generated based on AI/ML and the GCS and/or SGCS and/or NMSE of the first vector and the second vector (similar to step 1). In some implementations, the network device transmits a fourth RRC message to the terminal equipment, the fourth RRC message configuring CSI triggering states for the terminal equipment, each triggering state corresponding to a fourth CSI report configuration. In the fourth CSI report configuration, the terminal equipment is configured to transmit the true CSI, the CSI generated based on AI/ML and the GCS and/or SGCS and/or NMSE of the first vector and the second vector to the network device. The fourth CSI report configuration further includes the first codebook configuration. However, the network device does not require the terminal equipment to report the CSI generated based on codebooks. Specific implementations are given in subsection 3.3.1.1, and the field added to the CSI report configuration is given in subsection 3.3.1.

Step 6: making a decision by the network device according to a result of monitoring the performance of the second AI/ML model. A first possibility is that the network device decides to switch a codebook-based CSI feedback method to an AI/ML-based CSI feedback method. In some implementations, the network device configures a fifth CSI report configuration by transmitting an RRC message, so as to indicate the terminal equipment to use CSI feedback based on AI/ML. An AI/ML configuration in the fifth CSI report configuration may be identical to an AI/ML configuration in the fourth CSI report configuration. A second possibility is that the network device decides to proceed with using the codebook-based method for generating CSI, that is, it does not switch a codebook-based CSI feedback method to an AI/ML-based CSI feedback method. In some implementations, the network device configures a sixth CSI report configuration by transmitting an RRC message, so as to indicate the terminal equipment to use CSI feedback based on codebooks. The sixth CSI report configuration includes a codebook configuration (one of codebookConfig, codebookConfig-r16 and codebookConfig-r17), which is identical to a relevant configuration in the second CSI report configuration.

### Embodiment 18

In embodiment 18, for the case where the terminal equipment reports the true CSI, the CSI generated based on AI/ML and the GCS and/or SGCS and/or NMSE of the first vector and the second vector, the case of aperiodic CSI reports may be traversed. The manner of indicating by the DCI and/or the MAC CE without changing RRC configuration may be traversed, and reference may be made to embodiment 8 and embodiment 17 for details.

According to the embodiments of the first aspect of this disclosure, the terminal equipment is indicated to transmit at least two of the first CSI, the second CSI and the third CSI to the network device. Therefore, the network device may monitor the performance of the model used to generate CSI according to the received CSI.

### Embodiments of a Second Aspect

The embodiments of the second aspect provide a method for transmitting channel state information (CSI), applicable to a terminal equipment, the terminal equipment, such as the terminal equipment 202 in FIG. 2. For contents in the embodiments of the second aspect identical to those in the embodiments of the first aspect, reference may be made to the description of the embodiments of the first aspect, which shall not be repeated herein any further

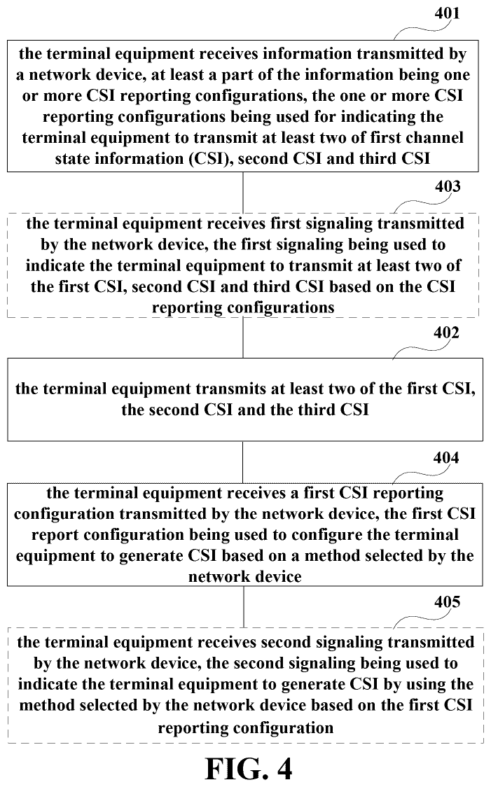

FIG. 4 is a schematic diagram of the method for transmitting channel state information of the embodiments of the second aspect. The method includes:
401: the terminal equipment receives information transmitted by a network device, at least a part of the information being one or more CSI reporting configurations, the one or more CSI reporting configurations being used for indicating the terminal equipment to transmit at least two of first channel state information (CSI), second CSI and third CSI; and
402: the terminal equipment transmits at least two of the first CSI, the second CSI and the third CSI,
wherein at least two of the first CSI, the second CSI and the third CSI are generated based on at least a part of identical channel state information reference signals (CSI-RSs) and/or CSI-RS resources.

In at least one embodiment,
at least a part of information of the first CSI is bit information of a spatial channel matrix or bit information of a right singular vector of the spatial channel matrix; and/or
the second CSI is obtained in a first method; and/or
the third CSI is obtained in a fourth method.

In at least one embodiment, at least a part of the first method is a method based on an artificial intelligence model.

In at least one embodiment, the first method is configured by the network device, or is specified in a protocol, or is determined and reported by the terminal equipment to the network device.

In at least one embodiment, at least a part of the fourth method is a codebook specified in 3GPP standardization.

In at least one embodiment, the spatial channel matrix is also able to be an index of the spatial channel matrix; and/or
the right singular vector is also able to be an index of the right singular vector.

In at least one embodiment, the bit information is obtained by scalar quantization and/or in a third method.

In at least one embodiment, the third method is a codebook specified in 3GPP standardization or a method obtained by expanding a value range of at least one parameter of a codebook specified in 3GPP standardization.

In at least one embodiment, the codebook specified in the 3GPP standardization is at least one of a type I single-panel codebook, a type I multi-panel codebook, a type II codebook, a type II port selection codebook, an enhanced type II codebook, an enhanced type II port selection codebook or a further enhanced type II port selection codebook.

In at least one embodiment, at least two of the first CSI, the second CSI and the third CSI are included in one or more CSI reports.

In at least one embodiment, the terminal equipment receives via first radio resource control (RRC) signaling the information transmitted by the network device.

In at least one embodiment, when the number of the CSI reporting configurations is one, the CSI reporting configuration is used to configure the terminal equipment to transmit at least two of the first CSI, the second CSI and the third CSI; or
when the number of the CSI reporting configurations is two, one of the CSI reporting configurations is used to configure the terminal equipment to transmit the first CSI and the second CSI, and the other one of the CSI reporting configurations is used to configure the terminal equipment to transmit the third CSI; or
when the number of the CSI reporting configurations is two, one of the CSI reporting configurations is used to configure the terminal equipment to transmit the first CSI and the third CSI, and the other one of the CSI reporting configurations is used to configure the terminal equipment to transmit the second CSI; or
when the number of the CSI reporting configurations is two, one of the CSI reporting configurations is used to configure the terminal equipment to transmit the second CSI and the third CSI, and the other one of the CSI reporting configurations is used to configure the terminal equipment to transmit the first CSI; or
when the number of the CSI report configurations is three, the three CSI reporting configurations are used to respectively configure the terminal equipment to transmit the first CSI, the second CSI and the third CSI.

In at least one embodiment, the first RRC signaling indicates the terminal equipment to transmit at least two of the first CSI, the second CSI and the third CSI.

In at least one embodiment, the CSI reporting configurations include a first field for indicating the terminal equipment to transmit the first CSI and/or the second CSI to the network device; and/or
a second field of the CSI reporting configurations indicates the terminal equipment by expanding a value range to transmit the first field of the first CSI and/or the second CSI to the network device.

In at least one embodiment, the first field includes a codebook configuration (codebookConfig) field.

In at least one embodiment, the CSI reporting configurations further include following fields corresponding to the first CSI and/or the second CSI:
a field of a report quantity, and/or a field of a reporting configuration type, and/or a field of a frequency-domain reporting granularity, and/or a field of a codebook type, and/or a field of a quantization method for generating the first CSI.

In at least one embodiment, in a case where at least two of the first CSI, the second CSI and the third CSI are included in one CSI report,
the CSI reporting configurations include at least two of the following parameters:
a codebook configuration parameter (codebookConfig-groundtruthCSI) for configuring the first CSI;
a codebook configuration parameter (codebookConfig-ai) for configuring the second CSI; and
a codebook configuration parameter (codebookConfig, or codebookConfig-r16, or codebookConfig-r17) for configuring the third CSI.

In at least one embodiment, a value of a first report quantity (reportQuantity, reportQuantity-r16, reportQuantity-r17) in the CSI reporting configurations indicates each of at least two of the first CSI, second CSI and third CSI in the CSI report transmitted by the terminal equipment to report a content indicated by the value of the first report quantity.

In at least one embodiment, when the CSI reporting configurations further include a value of the report quantity of the first CSI and/or a value of the report quantity of the second CSI,
the first CSI reports the content indicated by the value of the report quantity of the first CSI, and/or the second CSI reports the content indicated by the value of the report quantity of the second CSI,
and the third CSI reports the content indicated by the value of the first report quantity (reportQuantity, reportQuantity-r16, reportQuantity-r17).

In at least one embodiment, in a case where a CSI report includes one of the first CSI, the second CSI and the third CSI,
the CSI reporting configuration to which each CSI report respectively corresponds includes one of the following parameters:
a codebook configuration parameter (codebookConfig-groundtruthCSI) for configuring the first CSI;
a codebook configuration parameter (codebookConfig-ai) for configuring the second CSI; and
a codebook configuration parameter (codebookConfig, or codebookConfig-r16, or codebookConfig-r17) for configuring the third CSI.

As shown in FIG. 4, the method further includes:
403: the terminal equipment receives first signaling transmitted by the network device, the first signaling being used to indicate the terminal equipment to transmit at least two of the first CSI, second CSI and third CSI based on the CSI reporting configurations.

In at least one embodiment, the first signaling includes downlink control information (DCI) and/or a media access control control element (MAC CE).

In at least one embodiment, the first signaling includes a first information field, the first information field being used to indicate:
a method for generating CSI of a predetermined number of CSI reports under the CSI reporting configuration; or
a method for generating respective CSI of a predetermined number of CSI reports under the CSI reporting configuration.

In at least one embodiment, the method for generating CSI includes:
generating precoding matrix information of the CSI report in the first method, and closing being based on the fourth method and/or not reporting the first CSI; or
closing being based on the first method and/or not reporting the first CSI, the precoding matrix information of the CSI report being generated based on the fourth method.

In at least one embodiment, the first signaling includes a second information field, the second information field being used to indicate:
a second method for generating CSI of a predetermined number of CSI reports under the CSI reporting configuration; or
a second method for generating respective CSI of a predetermined number of CSI reports under the CSI reporting configuration.

In at least one embodiment, the second method for generating CSI includes:
generating first CSI, obtaining the CSI based on the first method and obtaining the CSI based on the fourth method; or
maintaining an existing method for generating CSI.

In at least one embodiment, the second method for generating CSI includes:
obtaining precoding matrix information of the CSI report based on the first method, and closing being based on the fourth method and/or not reporting the first CSI; or
closing being based on the first method and/or not reporting the first CSI, the precoding matrix information of the CSI report being generated based on the fourth method,
the CSI report including the first CSI, the CSI generated based on the first method being used and the CSI generated based on the fourth method being used, or
the CSI report including the first CSI and using the CSI generated based on the first method.

In at least one embodiment, as shown in FIG. 4, the method further includes:
404: the terminal equipment receives a first CSI reporting configuration transmitted by the network device, the first CSI report configuration being used to configure the terminal equipment to generate CSI based on a method selected by the network device; and
405: the terminal equipment receives second signaling transmitted by the network device, the second signaling being used to indicate the terminal equipment to generate CSI by using the method selected by the network device based on the first CSI reporting configuration.

### Embodiments of a Third Aspect

At least addressed to the same problem as the embodiments of the first aspect, the embodiments of the third aspect of this disclosure provide an apparatus for receiving channel state information (CSI), applicable to a network device, and corresponding to the embodiments of the first aspect.

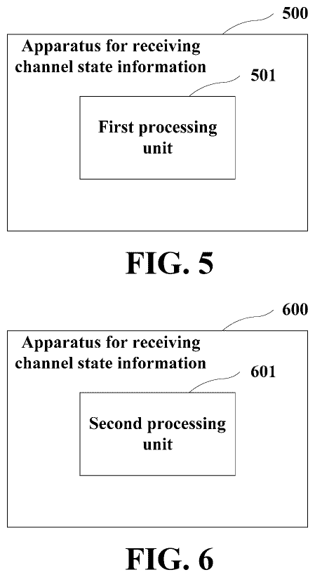

FIG. 5 is a schematic diagram of the apparatus for receiving channel state information (CSI) of the embodiments of the third aspect of this disclosure. As shown in FIG. 5, an apparatus 500 for receiving channel state information (CSI) includes a first processing unit 501.

The first processing unit 501 makes the network device execute the following operations:
transmitting information by the network device to a terminal equipment, at least a part of the information being one or more CSI reporting configurations, the one or more CSI reporting configurations being used for indicating the terminal equipment to transmit at least two of first channel state information (CSI), second CSI and third CSI; and
receiving, by the network device, at least two of the first CSI, the second CSI and the third CSI transmitted by the terminal equipment, wherein at least two of the first CSI, the second CSI and the third CSI are generated based on at least a part of identical channel state information reference signals (CSI-RSs) and/or CSI-RS resources.

In at least one embodiment, at least a part of information of the first CSI is bit information of a spatial channel matrix or bit information of a right singular vector of the spatial channel matrix; and/or
the second CSI is obtained in a first method; and/or
the third CSI is obtained in a fourth method.

In at least one embodiment, at least a part of the first method is a method based on an artificial intelligence model.

In at least one embodiment, the first method is configured by the network device, or is specified in a protocol, or is determined and reported by the terminal equipment to the network device.

In at least one embodiment, at a least part of the fourth method is a codebook specified in 3GPP standardization.

In at least one embodiment, the spatial channel matrix is also able to be an index of the spatial channel matrix; and/or
the right singular vector is also able to be an index of the right singular vector.

In at least one embodiment, the bit information is obtained by scalar quantization and/or in a third method.

In at least one embodiment, the third method is a codebook specified in 3GPP standardization or a method obtained by expanding a value range of at least one parameter of a codebook specified in 3GPP standardization.

In at least one embodiment, the codebook specified in the 3GPP standardization is at least one of a type I single-panel codebook, a type I multi-panel codebook, a type II codebook, a type II port selection codebook, an enhanced type II codebook, an enhanced type II port selection codebook or a further enhanced type II port selection codebook.

In at least one embodiment, at least two of the first CSI, the second CSI and the third CSI are included in one or more CSI reports.

In at least one embodiment, the network device transmits the information to the terminal equipment via first radio resource control (RRC) signaling.

In at least one embodiment, when the number of the CSI reporting configurations is one, the CSI reporting configuration is used to configure the terminal equipment to transmit at least two of the first CSI, the second CSI and the third CSI; or
when the number of the CSI reporting configurations is two, one of the CSI reporting configurations is used to configure the terminal equipment to transmit the first CSI and the second CSI, and the other one of the CSI reporting configurations is used to configure the terminal equipment to transmit the third CSI; or
when the number of the CSI reporting configurations is two, one of the CSI reporting configurations is used to configure the terminal equipment to transmit the first CSI and the third CSI, and the other one of the CSI reporting configurations is used to configure the terminal equipment to transmit the second CSI; or
when the number of the CSI reporting configurations is two, one of the CSI reporting configurations is used to configure the terminal equipment to transmit the second CSI and the third CSI, and the other one of the CSI reporting configurations is used to configure the terminal equipment to transmit the first CSI; or
when the number of the CSI report configurations is three, the three CSI reporting configurations are used to respectively configure the terminal equipment to transmit the first CSI, the second CSI and the third CSI.

In at least one embodiment, the first RRC signaling indicates the terminal equipment to transmit at least two of the first CSI, the second CSI and the third CSI.

In at least one embodiment, the CSI reporting configurations include a first field for indicating the terminal equipment to transmit the first CSI and/or the second CSI to the network device; and/or
a second field of the CSI reporting configurations indicates the terminal equipment by expanding a value range to transmit the first field of the first CSI and/or the second CSI to the network device.

In at least one embodiment, the first field includes a codebook configuration (codebookConfig) field.

In at least one embodiment, the CSI reporting configurations further include following fields corresponding to the first CSI and/or the second CSI:
a field of a report quantity, and/or a field of a reporting configuration type, and/or a field of a frequency-domain reporting granularity, and/or a field of a codebook type, and/or a field of a quantization method for generating the first CSI.

In at least one embodiment, in a case where at least two of the first CSI, the second CSI and the third CSI are included in one CSI report,
the CSI reporting configurations include at least two of the following parameters:
a codebook configuration parameter (codebookConfig-groundtruthCSI) for configuring the first CSI;
a codebook configuration parameter (codebookConfig-ai) for configuring the second CSI; and
a codebook configuration parameter (codebookConfig, or codebookConfig-r16, or codebookConfig-r17) for configuring the third CSI.

In at least one embodiment, a value of a first report quantity (reportQuantity, reportQuantity-r16, reportQuantity-r17) in the CSI reporting configurations indicates each of at least two of the first CSI, second CSI and third CSI in the CSI report transmitted by the terminal equipment to report a content indicated by the value of the first report quantity.

In at least one embodiment, when the CSI reporting configurations further include a value of the report quantity of the first CSI and/or a value of the report quantity of the second CSI,
the first CSI reports the content indicated by the value of the report quantity of the first CSI, and/or the second CSI reports the content indicated by the value of the report quantity of the second CSI,
and the third CSI reports the content indicated by the value of the first report quantity (reportQuantity, reportQuantity-r16, reportQuantity-r17).

In at least one embodiment, in a case where a CSI report includes one of the first CSI, the second CSI and the third CSI,
the CSI reporting configuration to which each CSI report respectively corresponds includes one of the following parameters:
a codebook configuration parameter for configuring the first CSI;
a codebook configuration parameter for configuring the second CSI; and
a codebook configuration parameter for configuring the third CSI.

In at least one embodiment, the first processing unit further makes the network device execute the following operations:
transmitting first signaling by the network device to the terminal equipment, the first signaling being used to indicate the terminal equipment to transmit at least two of the first CSI, second CSI and third CSI based on the CSI reporting configurations.

In at least one embodiment, the first signaling includes downlink control information (DCI) and/or a media access control control element (MAC CE).

In at least one embodiment, the first signaling includes a first information field, the first information field being used to indicate:
a method for generating CSI of a predetermined number of CSI reports under the CSI reporting configuration; or
a method for generating respective CSI of a predetermined number of CSI reports under the CSI reporting configuration.

In at least one embodiment, the method for generating CSI includes:
generating precoding matrix information of the CSI report in the first method, and closing being based on the fourth method and/or not reporting the first CSI; or
closing being based on the first method and/or not reporting the first CSI, the precoding matrix information of the CSI report being generated based on the fourth method.

In at least one embodiment, the first signaling includes a second information field, the second information field being used to indicate:
a second method for generating CSI of a predetermined number of CSI reports under the CSI reporting configuration; or
a second method for generating respective CSI of a predetermined number of CSI reports under the CSI reporting configuration.

In at least one embodiment, the second method for generating CSI includes:
generating first CSI, obtaining the CSI based on the first method and obtaining the CSI based on the fourth method; or
maintaining an existing method for generating CSI.

In at least one embodiment, the second method for generating CSI includes:
obtaining precoding matrix information of the CSI report based on the first method, and closing being based on the fourth method and/or not reporting the first CSI; or
closing being based on the first method and/or not reporting the first CSI, the precoding matrix information of the CSI report being generated based on the fourth method,
the CSI report including the first CSI, the CSI generated based on the first method being used and the CSI generated based on the fourth method being used, or
the CSI report including the first CSI and using the CSI generated based on the first method.

In at least one embodiment, the first processing unit further makes the network device execute the following operations:
selecting by the network device based on at least two of the first CSI, the second CSI and the third CSI, a method for generating CSI by the terminal equipment.

In at least one embodiment, the first processing unit further makes the network device execute the following operations:
transmitting a first CSI reporting configuration by the network device to the terminal equipment, the first CSI report configuration being used to configure the terminal equipment to generate CSI based on the method selected by the network device.

In at least one embodiment, the first processing unit further makes the network device execute the following operations:
transmitting second signaling by the network device to the terminal equipment, the second signaling being used to indicate the terminal equipment to generate CSI by using the method selected by the network device based on the first CSI reporting configuration.

### Embodiments of a Fourth Aspect

The embodiments of the fourth aspect of this disclosure provide an apparatus for transmitting channel state information (CSI), applicable to a network device, and corresponding to the embodiments of the second aspect.

FIG. 6 is a schematic diagram of the apparatus for transmitting channel state information (CSI) of the embodiments of the fourth aspect of this disclosure. As shown in FIG. 6, an apparatus 600 includes a second processing unit 601.

In at least one embodiment, the second processing unit 601 makes the terminal equipment execute the following operations:
receiving, by the terminal equipment, information transmitted by a network device, at least a part of the information being one or more CSI reporting configurations, the one or more CSI reporting configurations being used for indicating the terminal equipment to transmit at least two of first channel state information (CSI), second CSI and third CSI; and
transmitting at least two of the first CSI, the second CSI and the third CSI by the terminal equipment, wherein at least two of the first CSI, the second CSI and the third CSI are generated based on at least a part of identical channel state information reference signals (CSI-RSs) and/or CSI-RS resources.

In at least one embodiment, at least a part of information of the first CSI is bit information of a spatial channel matrix or bit information of a right singular vector of the spatial channel matrix; and/or
the second CSI is obtained in a first method; and/or
the third CSI is obtained in a fourth method.

In at least one embodiment, at least a part of the first method is a method based on an artificial intelligence model.

In at least one embodiment, the first method is configured by the network device, or is specified in a protocol, or is determined and reported by the terminal equipment to the network device.

In at least one embodiment, at a least part of the fourth method is a codebook specified in 3GPP standardization.

In at least one embodiment, the spatial channel matrix is also able to be an index of the spatial channel matrix; and/or
the right singular vector is also able to be an index of the right singular vector.

In at least one embodiment, the bit information is obtained by scalar quantization and/or in a third method.

In at least one embodiment, the third method is a codebook specified in 3GPP standardization or a method obtained by expanding a value range of at least one parameter of a codebook specified in 3GPP standardization.

In at least one embodiment, the codebook specified in the 3GPP standardization is at least one of a type I single-panel codebook, a type I multi-panel codebook, a type II codebook, a type II port selection codebook, an enhanced type II codebook, an enhanced type II port selection codebook or a further enhanced type II port selection codebook.

In at least one embodiment, at least two of the first CSI, the second CSI and the third CSI are included in one or more CSI reports.

In at least one embodiment, via first radio resource control (RRC) signaling, the terminal equipment receives the information transmitted by the network device.

In at least one embodiment, when the number of the CSI reporting configurations is one, the CSI reporting configuration is used to configure the terminal equipment to transmit at least two of the first CSI, the second CSI and the third CSI; or
when the number of the CSI reporting configurations is two, one of the CSI reporting configurations is used to configure the terminal equipment to transmit the first CSI and the second CSI, and the other one of the CSI reporting configurations is used to configure the terminal equipment to transmit the third CSI; or
when the number of the CSI reporting configurations is two, one of the CSI reporting configurations is used to configure the terminal equipment to transmit the first CSI and the third CSI, and the other one of the CSI reporting configurations is used to configure the terminal equipment to transmit the second CSI; or
when the number of the CSI reporting configurations is two, one of the CSI reporting configurations is used to configure the terminal equipment to transmit the second CSI and the third CSI, and the other one of the CSI reporting configurations is used to configure the terminal equipment to transmit the first CSI; or
when the number of the CSI report configurations is three, the three CSI reporting configurations are used to respectively configure the terminal equipment to transmit the first CSI, the second CSI and the third CSI.

In at least one embodiment, the first RRC signaling indicates the terminal equipment to transmit at least two of the first CSI, the second CSI and the third CSI.

In at least one embodiment, the CSI reporting configurations include a first field for indicating the terminal equipment to transmit the first CSI and/or the second CSI to the network device; and/or
a second field of the CSI reporting configurations indicates the terminal equipment by expanding a value range to transmit the first field of the first CSI and/or the second CSI to the network device.

In at least one embodiment, the first field includes a codebook configuration (codebookConfig) field.

In at least one embodiment, the CSI reporting configurations further include following fields corresponding to the first CSI and/or the second CSI:
a field of a report quantity, and/or a field of a reporting configuration type, and/or a field of a frequency-domain reporting granularity, and/or a field of a codebook type, and/or a field of a quantization method for generating the first CSI.

In at least one embodiment, in a case where at least two of the first CSI, the second CSI and the third CSI are included in one CSI report,
the CSI reporting configurations include at least two of the following parameters:
a codebook configuration parameter (codebookConfig-groundtruthCSI) for configuring the first CSI;
a codebook configuration parameter (codebookConfig-ai) for configuring the second CSI; and
a codebook configuration parameter (codebookConfig, or codebookConfig-r16, or codebookConfig-r17) for configuring the third CSI.

In at least one embodiment, a value of a first report quantity (reportQuantity, reportQuantity-r16, reportQuantity-r17) in the CSI reporting configurations indicates each of at least two of the first CSI, second CSI and third CSI in the CSI report transmitted by the terminal equipment to report a content indicated by the value of the first report quantity.

In at least one embodiment, when the CSI reporting configurations further include a value of the report quantity of the first CSI and/or a value of the report quantity of the second CSI,
the first CSI reports the content indicated by the value of the report quantity of the first CSI, and/or the second CSI reports the content indicated by the value of the report quantity of the second CSI,
and the third CSI reports the content indicated by the value of the first report quantity (reportQuantity, reportQuantity-r16, reportQuantity-r17).

In at least one embodiment, in a case where a CSI report includes one of the first CSI, the second CSI and the third CSI, the CSI reporting configuration to which each CSI report respectively corresponds includes one of the following parameters:
a codebook configuration parameter (codebookConfig-groundtruthCSI) for configuring the first CSI;
a codebook configuration parameter (codebookConfig-ai) for configuring the second CSI; and
a codebook configuration parameter (codebookConfig, codebookConfig-r16 or codebookConfig-r17) for configuring the third CSI.

In at least one embodiment, the second processing unit further controls the terminal equipment to execute the following operations:
receiving by the terminal equipment first signaling transmitted by the network device, the first signaling being used to indicate the terminal equipment to transmit at least two of the first CSI, second CSI and third CSI based on the CSI reporting configurations.

In at least one embodiment, the first signaling includes downlink control information (DCI) and/or a media access control control element (MAC CE).

In at least one embodiment, the first signaling includes a first information field, the first information field being used to indicate:
a method for generating CSI of a predetermined number of CSI reports under the CSI reporting configuration; or
a method for generating respective CSI of a predetermined number of CSI reports under the CSI reporting configuration.

In at least one embodiment, the method for generating CSI includes:
generating precoding matrix information of the CSI report in the first method, and closing being based on the fourth method and/or not reporting the first CSI; or
closing being based on the first method and/or not reporting the first CSI, the precoding matrix information of the CSI report being generated based on the fourth method.

In at least one embodiment, the first signaling includes a second information field, the second information field being used to indicate:
a second method for generating CSI of a predetermined number of CSI reports under the CSI reporting configuration; or
a second method for generating respective CSI of a predetermined number of CSI reports under the CSI reporting configuration.

In at least one embodiment, the second method for generating CSI includes:
generating first CSI, obtaining the CSI based on the first method and obtaining the CSI based on the fourth method; or
maintaining an existing method for generating CSI.

In at least one embodiment, the second method for generating CSI includes:
obtaining precoding matrix information of the CSI report based on the first method, and closing being based on the fourth method and/or not reporting the first CSI; or
closing being based on the first method and/or not reporting the first CSI, the precoding matrix information of the CSI report being generated based on the fourth method,
the CSI report including the first CSI, the CSI generated based on the first method being used and the CSI generated based on the fourth method being used, or
the CSI report including the first CSI and using the CSI generated based on the first method.

In at least one embodiment, the second processing unit controls the terminal equipment to execute the following operations:
receiving by the terminal equipment a first CSI reporting configuration transmitted by the network device,
the first CSI report configuration being used to configure the terminal equipment to generate CSI based on a method selected by the network device.

In at least one embodiment, the second processing unit controls the terminal equipment to execute the following operations:
receiving by the terminal equipment second signaling transmitted by the network device,
the second signaling being used to indicate the terminal equipment to generate CSI by using the method selected by the network device based on the first CSI reporting configuration.

### Embodiments of a Fifth Aspect

The embodiments of the fifth aspect of this disclosure provide a communication system, including a network device and a terminal equipment.

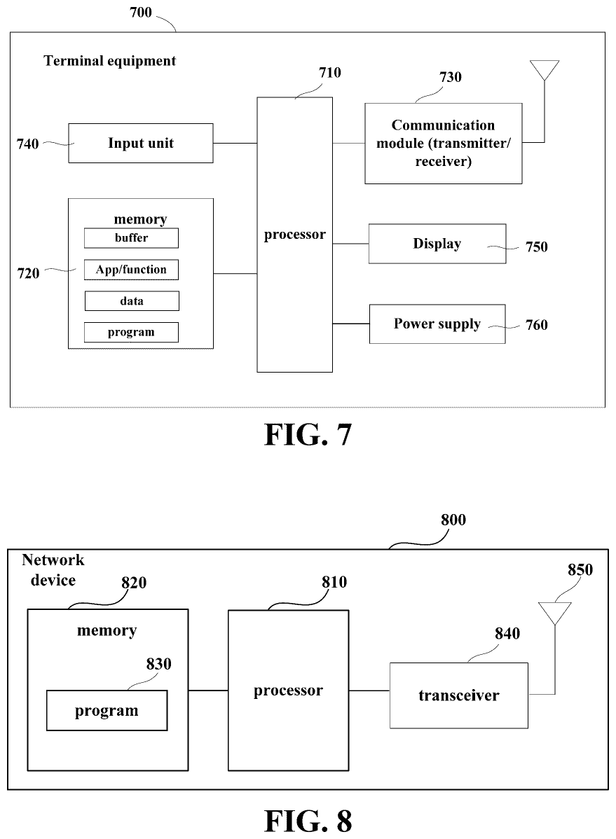

FIG. 7 is a schematic diagram of the terminal equipment of the embodiments of the fifth aspect of this disclosure. As shown in FIG. 7, a terminal equipment 700 (such as corresponding to the terminal equipment 202 in FIG. 2) may include a processor 710 and a memory 720, the memory 720 storing data and a program and being coupled to the processor 710. It should be noted that this figure is illustrative only, and other types of structures may also be used, so as to supplement or replace this structure and achieve a telecommunications function or other functions.

For example, the processor 710 may be configured to execute a program to carry out the method described in the embodiments of the second aspect.

As shown in FIG. 7, the terminal equipment 700 may further include a communication module 730, an input unit 740, a display 750, and a power supply 760, wherein functions of the above components are similar to those in the related art, which shall not be described herein any further. It should be noted that the terminal equipment 700 does not necessarily include all the parts shown in FIG. 7, and the above components are not necessary. Furthermore, the terminal equipment 700 may include parts not shown in FIG. 7, and the related art may be referred to.

FIG. 8 is a schematic diagram of the network device of the embodiments of the fifth aspect. As shown in FIG. 8, a network device 800 (such as corresponding to the network device 201 in FIG. 2) may include a processor 810 (such as a central processing unit (CPU) and a memory 820, the memory 820 being coupled to the processor 810. The memory 820 may store various data, and furthermore, it may store a program 830 for information processing, and execute the program under control of the processor 810.

For example, the processor 810 may be configured to execute a program to carry out the method described in the embodiments of the first aspect.

Furthermore, as shown in FIG. 8, the network device 800 may include a transceiver 840, and an antenna 850, etc. Functions of the above components are similar to those in the related art, and shall not be described herein any further. It should be noted that the network device 800 does not necessarily include all the parts shown in FIG. 8, and furthermore, the network device 800 may include parts not shown in FIG. 8, and the related art may be referred to.

An embodiments of this disclosure provides a computer readable program, which, when executed in a terminal equipment, causes the terminal equipment to carry out the method as described in the embodiments of the second aspect.

An embodiments of this disclosure provides a computer storage medium, including a computer readable program, which causes a terminal equipment to carry out the method as described in the embodiments of the second aspect.

An embodiments of this disclosure provides a computer readable program, which, when executed in a network device, causes the network device to carry out the method as described in the embodiments of the first aspect.

An embodiments of this disclosure provides a computer storage medium, including a computer readable program, which causes a network device to carry out the method as described in the embodiments of the first aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

### A Method at a Network Device Side:

1. A method for receiving channel state information (CSI), applicable to a network device, the method including:
transmitting information by the network device to a terminal equipment, at least a part of the information being one or more CSI reporting configurations, the one or more CSI reporting configurations being used for indicating the terminal equipment to transmit at least two of first channel state information (CSI), second CSI and third CSI; and
receiving, by the network device, at least two of the first CSI, the second CSI and the third CSI transmitted by the terminal equipment,
wherein at least two of the first CSI, the second CSI and the third CSI are generated based on at least a part of identical channel state information reference signals (CSI-RSs) and/or CSI-RS resources.

2. The method according to supplement 1, wherein,
at least a part of information of the first CSI is bit information of a spatial channel matrix or bit information of a right singular vector of the spatial channel matrix; and/or
the second CSI is obtained in a first method; and/or
the third CSI is obtained in a fourth method.

2a. The method according to supplement 2, wherein,
at least a part of the first method is a method based on an artificial intelligence model.

2b. The method according to supplement 2, wherein,
the first method is configured by the network device, or is specified in a protocol, or is determined and reported by the terminal equipment to the network device.

2c. The method according to supplement 2, wherein,
at a least part of the fourth method is a codebook specified in 3GPP standardization.

2d. The method according to supplement 2, wherein,
the spatial channel matrix is also able to be an index of the spatial channel matrix; and/or
the right singular vector is also able to be an index of the right singular vector.

3. The method according to supplement 2, wherein,
the bit information is obtained by scalar quantization and/or in a third method.

3a. The method according to supplement 3, wherein,
the third method is a codebook specified in 3GPP standardization or a method obtained by expanding a value range of at least one parameter of a codebook specified in 3GPP standardization.

3b. The method according to supplement 2c or 3a, wherein,
the codebook specified in the 3GPP standardization is at least one of a type I single-panel codebook, a type I multi-panel codebook, a type II codebook, a type II port selection codebook, an enhanced type II codebook, an enhanced type II port selection codebook or a further enhanced type II port selection codebook.

4. The method according to supplement 1, wherein,
at least two of the first CSI, the second CSI and the third CSI are included in one or more CSI reports.

5. The method according to supplement 1, wherein,
the network device transmits the information to the terminal equipment via first radio resource control (RRC) signaling.

6. The method according to supplement 5, wherein,
when the number of the CSI reporting configurations is one, the CSI reporting configuration is used to configure the terminal equipment to transmit at least two of the first CSI, the second CSI and the third CSI; or
when the number of the CSI reporting configurations is two, one of the CSI reporting configurations is used to configure the terminal equipment to transmit the first CSI and the second CSI, and the other one of the CSI reporting configurations is used to configure the terminal equipment to transmit the third CSI; or
when the number of the CSI reporting configurations is two, one of the CSI reporting configurations is used to configure the terminal equipment to transmit the first CSI and the third CSI, and the other one of the CSI reporting configurations is used to configure the terminal equipment to transmit the second CSI; or
when the number of the CSI reporting configurations is two, one of the CSI reporting configurations is used to configure the terminal equipment to transmit the second CSI and the third CSI, and the other one of the CSI reporting configurations is used to configure the terminal equipment to transmit the first CSI; or
when the number of the CSI report configurations is three, the three CSI reporting configurations are used to respectively configure the terminal equipment to transmit the first CSI, the second CSI and the third CSI.

7. The method according to supplement 5, wherein,
the first RRC signaling indicates the terminal equipment to transmit at least two of the first CSI, the second CSI and the third CSI.

8. The method according to supplement 1, wherein,
the CSI reporting configurations include a first field for indicating the terminal equipment to transmit the first CSI and/or the second CSI to the network device; and/or
a second field of the CSI reporting configurations indicates the terminal equipment by expanding a value range to transmit the first field of the first CSI and/or the second CSI to the network device.

9. The method according to supplement 8, wherein,
the first field includes a codebook configuration (codebookConfig) field.

10. The method according to supplement 8, wherein,
the CSI reporting configurations further include following fields corresponding to the first CSI and/or the second CSI:
a field of a report quantity, and/or a field of a reporting configuration type, and/or a field of a frequency-domain reporting granularity, and/or a field of a codebook type, and/or a field of a quantization method for generating the first CSI.

11. The method according to supplement 1, wherein,
in a case where at least two of the first CSI, the second CSI and the third CSI are included in one CSI report,
the CSI reporting configurations include at least two of the following parameters:
a codebook configuration parameter (codebookConfig-groundtruthCSI) for configuring the first CSI;
a codebook configuration parameter (codebookConfig-ai) for configuring the second CSI; and
a codebook configuration parameter (codebookConfig, or codebookConfig-r16, or codebookConfig-r17) for configuring the third CSI.

12. The method according to supplement 11, wherein,
a value of a first report quantity (reportQuantity, reportQuantity-r16, reportQuantity-r17) in the CSI reporting configurations indicates each of at least two of the first CSI, second CSI and third CSI in the CSI report transmitted by the terminal equipment to report a content indicated by the value of the first report quantity.

13. The method according to supplement 12, wherein,
when the CSI reporting configurations further include a value of the report quantity of the first CSI and/or a value of the report quantity of the second CSI,
the first CSI reports the content indicated by the value of the report quantity of the first CSI, and/or the second CSI reports the content indicated by the value of the report quantity of the second CSI,
and the third CSI reports the content indicated by the value of the first report quantity (reportQuantity, reportQuantity-r16, reportQuantity-r17).

14. The method according to supplement 1, wherein,
in a case where a CSI report includes one of the first CSI, the second CSI and the third CSI,
the CSI reporting configuration to which each CSI report respectively corresponds includes one of the following parameters:
a codebook configuration parameter (codebookConfig-groundtruthCSI) for configuring the first CSI;
a codebook configuration parameter (codebookConfig-ai) for configuring the second CSI; and
a codebook configuration parameter (codebookConfig, or codebookConfig-r16, or codebookConfig-r17) for configuring the third CSI.

15. The method according to supplement 1, wherein the method further includes:
transmitting first signaling by the network device to the terminal equipment, the first signaling being used to indicate the terminal equipment to transmit at least two of the first CSI, second CSI and third CSI based on the CSI reporting configurations.

16. The method according to supplement 15, wherein,
the first signaling includes downlink control information (DCI) and/or a media access control control element (MAC CE).

17. The method according to supplement 15, wherein,
the first signaling includes a first information field, the first information field being used to indicate:
a method for generating CSI of a predetermined number of CSI reports under the CSI reporting configuration; or
a method for generating respective CSI of a predetermined number of CSI reports under the CSI reporting configuration.

18. The method according to supplement 17, wherein,
the method for generating CSI includes:
generating precoding matrix information of the CSI report in the first method, and closing being based on the fourth method and/or not reporting the first CSI; or
closing being based on the first method and/or not reporting the first CSI, the precoding matrix information of the CSI report being generated based on the fourth method.

19. The method according to supplement 15 or 17, wherein,
the first signaling includes a second information field, the second information field being used to indicate:
a second method for generating CSI of a predetermined number of CSI reports under the CSI reporting configuration; or
a second method for generating respective CSI of a predetermined number of CSI reports under the CSI reporting configuration.

20. The method according to supplement 19, wherein,
the second method for generating CSI includes:
generating first CSI, obtaining the CSI based on the first method and obtaining the CSI based on the fourth method; or
maintaining an existing method for generating CSI.

21. The method according to supplement 19, wherein,
the second method for generating CSI includes:
obtaining precoding matrix information of the CSI report based on the first method, and closing being based on the fourth method and/or not reporting the first CSI; or
closing being based on the first method and/or not reporting the first CSI, the precoding matrix information of the CSI report being generated based on the fourth method,
the CSI report including the first CSI, the CSI generated based on the first method being used and the CSI generated based on the fourth method being used, or
the CSI report including the first CSI and using the CSI generated based on the first method.

22. The method according to any one of supplements 1-21, wherein the method further includes:
selecting by the network device based on at least two of the first CSI, the second CSI and the third CSI, a method for generating CSI by the terminal equipment.

23. The method according to supplement 22, wherein the method further includes:
transmitting a first CSI reporting configuration by the network device to the terminal equipment,
the first CSI report configuration being used to configure the terminal equipment to generate CSI based on the method selected by the network device.

24. The method according to supplement 22, wherein the method further includes:
transmitting second signaling by the network device to the terminal equipment,
the second signaling being used to indicate the terminal equipment to generate CSI by using the method selected by the network device based on the first CSI reporting configuration.

### A Method at Terminal Equipment Side:

1. A method for transmitting channel state information (CSI), applicable to a terminal equipment, the method including:
receiving, by the terminal equipment, information transmitted by a network device, at least a part of the information being one or more CSI reporting configurations, the one or more CSI reporting configurations being used for indicating the terminal equipment to transmit at least two of first channel state information (CSI), second CSI and third CSI; and
transmitting at least two of the first CSI, the second CSI and the third CSI by the terminal equipment,
wherein at least two of the first CSI, the second CSI and the third CSI are generated based on at least a part of identical channel state information reference signals (CSI-RSs) and/or CSI-RS resources.

2. The method according to supplement 1, wherein,
at least a part of information of the first CSI is bit information of a spatial channel matrix or bit information of a right singular vector of the spatial channel matrix; and/or
the second CSI is obtained in a first method; and/or
the third CSI is obtained in a fourth method.

2a. The method according to supplement 2, wherein,
at least a part of the first method is a method based on an artificial intelligence model.

2b. The method according to supplement 2, wherein,
the first method is configured by the network device, or is specified in a protocol, or is determined and reported by the terminal equipment to the network device.

2c. The method according to supplement 2, wherein,
at a least part of the fourth method is a codebook specified in 3GPP standardization.

2d. The method according to supplement 2, wherein,
the spatial channel matrix is also able to be an index of the spatial channel matrix; and/or
the right singular vector is also able to be an index of the right singular vector.

3. The method according to supplement 2, wherein,
the bit information is obtained by scalar quantization and/or in a third method.

3a. The method according to supplement 3, wherein,
the third method is a codebook specified in 3GPP standardization or a method obtained by expanding a value range of at least one parameter of a codebook specified in 3GPP standardization.

3b. The method according to supplement 2c or 3a, wherein,
the codebook specified in the 3GPP standardization is at least one of a type I single-panel codebook, a type I multi-panel codebook, a type II codebook, a type II port selection codebook, an enhanced type II codebook, an enhanced type II port selection codebook or a further enhanced type II port selection codebook.

4. The method according to supplement 1, wherein,
at least two of the first CSI, the second CSI and the third CSI are included in one or more CSI reports.

5. The method according to supplement 1, wherein,
the terminal equipment receives via first radio resource control (RRC) signaling the information transmitted by the network device.

6. The method according to supplement 5, wherein,
when the number of the CSI reporting configurations is one, the CSI reporting configuration is used to configure the terminal equipment to transmit at least two of the first CSI, the second CSI and the third CSI; or
when the number of the CSI reporting configurations is two, one of the CSI reporting configurations is used to configure the terminal equipment to transmit the first CSI and the second CSI, and the other one of the CSI reporting configurations is used to configure the terminal equipment to transmit the third CSI; or
when the number of the CSI reporting configurations is two, one of the CSI reporting configurations is used to configure the terminal equipment to transmit the first CSI and the third CSI, and the other one of the CSI reporting configurations is used to configure the terminal equipment to transmit the second CSI; or
when the number of the CSI reporting configurations is two, one of the CSI reporting configurations is used to configure the terminal equipment to transmit the second CSI and the third CSI, and the other one of the CSI reporting configurations is used to configure the terminal equipment to transmit the first CSI; or
when the number of the CSI report configurations is three, the three CSI reporting configurations are used to respectively configure the terminal equipment to transmit the first CSI, the second CSI and the third CSI.

7. The method according to supplement 5, wherein,
the first RRC signaling indicates the terminal equipment to transmit at least two of the first CSI, the second CSI and the third CSI.

8. The method according to supplement 1, wherein,
the CSI reporting configurations include a first field for indicating the terminal equipment to transmit the first CSI and/or the second CSI to the network device; and/or
a second field of the CSI reporting configurations indicates the terminal equipment by expanding a value range to transmit the first field of the first CSI and/or the second CSI to the network device.

9. The method according to supplement 8, wherein,
the first field includes a codebook configuration (codebookConfig) field.

10. The method according to supplement 8, wherein,
the CSI reporting configurations further include following fields corresponding to the first CSI and/or the second CSI:
a field of a report quantity, and/or a field of a reporting configuration type, and/or a field of a frequency-domain reporting granularity, and/or a field of a codebook type, and/or a field of a quantization method for generating the first CSI.

11. The method according to supplement 1, wherein,
in a case where at least two of the first CSI, the second CSI and the third CSI are included in one CSI report,
the CSI reporting configurations include at least two of the following parameters:
a codebook configuration parameter (codebookConfig-groundtruthCSI) for configuring the first CSI;
a codebook configuration parameter (codebookConfig-ai) for configuring the second CSI; and
a codebook configuration parameter (codebookConfig, or codebookConfig-r16, or codebookConfig-r17) for configuring the third CSI.

12. The method according to supplement 11, wherein,
a value of a first report quantity (reportQuantity, reportQuantity-r16, reportQuantity-r17) in the CSI reporting configurations indicates each of at least two of the first CSI, second CSI and third CSI in the CSI report transmitted by the terminal equipment to report a content indicated by the value of the first report quantity.

13. The method according to supplement 12, wherein,
when the CSI reporting configurations further include a value of the report quantity of the first CSI and/or a value of the report quantity of the second CSI,
the first CSI reports the content indicated by the value of the report quantity of the first CSI, and/or the second CSI reports the content indicated by the value of the report quantity of the second CSI,
and the third CSI reports the content indicated by the value of the first report quantity (reportQuantity, reportQuantity-r16, reportQuantity-r17).

14. The method according to supplement 1, wherein,
in a case where a CSI report includes one of the first CSI, the second CSI and the third CSI,
the CSI reporting configuration to which each CSI report respectively corresponds includes one of the following parameters:
a codebook configuration parameter (codebookConfig-groundtruthCSI) for configuring the first CSI;
a codebook configuration parameter (codebookConfig-ai) for configuring the second CSI; and
a codebook configuration parameter (codebookConfig, or codebookConfig-r16, or codebookConfig-r17) for configuring the third CSI.

15. The method according to supplement 1, wherein the method further includes:
receiving by the terminal equipment first signaling transmitted by the network device, the first signaling being used to indicate the terminal equipment to transmit at least two of the first CSI, second CSI and third CSI based on the CSI reporting configurations.

16. The method according to supplement 15, wherein,
the first signaling includes downlink control information (DCI) and/or a media access control control element (MAC CE).

17. The method according to supplement 15, wherein,
the first signaling includes a first information field, the first information field being used to indicate:
a method for generating CSI of a predetermined number of CSI reports under the CSI reporting configuration; or
a method for generating respective CSI of a predetermined number of CSI reports under the CSI reporting configuration.

18. The method according to supplement 17, wherein,
the method for generating CSI includes:
generating precoding matrix information of the CSI report in the first method, and closing being based on the fourth method and/or not reporting the first CSI; or
closing being based on the first method and/or not reporting the first CSI, the precoding matrix information of the CSI report being generated based on the fourth method.

19. The method according to supplement 15 or 17, wherein,
the first signaling includes a second information field, the second information field being used to indicate:
a second method for generating CSI of a predetermined number of CSI reports under the CSI reporting configuration; or
a second method for generating respective CSI of a predetermined number of CSI reports under the CSI reporting configuration.

20. The method according to supplement 19, wherein,
the second method for generating CSI includes:
generating first CSI, obtaining the CSI based on the first method and obtaining the CSI based on the fourth method; or
maintaining an existing method for generating CSI.

21. The method according to supplement 19, wherein,
the second method for generating CSI includes:
obtaining precoding matrix information of the CSI report based on the first method, and closing being based on the fourth method and/or not reporting the first CSI; or
closing being based on the first method and/or not reporting the first CSI, the precoding matrix information of the CSI report being generated based on the fourth method,
the CSI report including the first CSI, the CSI generated based on the first method being used and the CSI generated based on the fourth method being used, or
the CSI report including the first CSI and using the CSI generated based on the first method.

22. The method according to any one of supplements 1-21, wherein the method further includes:
receiving by the terminal equipment a first CSI reporting configuration transmitted by the network device,
the first CSI report configuration being used to configure the terminal equipment to generate CSI based on a method selected by the network device.

23. The method according to supplement 22, wherein the method further includes:
receiving by the terminal equipment second signaling transmitted by the network device,
the second signaling being used to indicate the terminal equipment to generate CSI by using the method selected by the network device based on the first CSI reporting configuration.

What is claimed is:

1. An apparatus for receiving channel state information (CSI), applicable to a network device, the apparatus comprising:
first processor circuitry making the network device execute the following:
transmitting information by the network device to a terminal equipment, at least a part of the information being one or more CSI reporting configurations, the one or more CSI reporting configurations being used for indicating the terminal equipment to transmit at least two of first channel state information (CSI), second CSI and third CSI; and
receiving, by the network device, at least two of the first CSI, the second CSI and the third CSI transmitted by the terminal equipment,
wherein at least two of the first CSI, the second CSI and the third CSI are generated based on at least a part of identical channel state information reference signals (CSI-RSs) and/or CSI-RS resources.

2. The apparatus according to claim 1, wherein,
at least a part of information of the first CSI is bit information of a spatial channel matrix or bit information of a right singular vector of the spatial channel matrix; and/or
the second CSI is obtained in a first method; and/or
the third CSI is obtained in a fourth method.

3. The apparatus according to claim 2, wherein,
at least a part of the first method is a method based on an artificial intelligence model.

4. The apparatus according to claim 2, wherein,
at least a part of the fourth method is a codebook specified in 3GPP standardization.

5. The apparatus according to claim 1, wherein,
at least two of the first CSI, the second CSI and the third CSI are included in one or more CSI reports.

6. The apparatus according to claim 1, wherein,
the network device transmits the information to the terminal equipment via first radio resource control (RRC) signaling.

7. The apparatus according to claim 1, wherein,
the CSI reporting configurations comprise a first field for indicating the terminal equipment to transmit the first CSI and/or the second CSI to the network device; and/or
a second field of the CSI reporting configurations indicates the terminal equipment by expanding a value range to transmit a first field of the first CSI and/or the second CSI to the network device.

8. The apparatus according to claim 1, wherein,
in a case where at least two of the first CSI, the second CSI and the third CSI are included in one CSI report,
the CSI reporting configurations comprise at least two of the following parameters:
a codebook configuration parameter for configuring the first CSI;
a codebook configuration parameter for configuring the second CSI; or
a codebook configuration parameter for configuring the third CSI.

9. The apparatus according to claim 1, wherein,
in a case where one of the first CSI, the second CSI and the third CSI is included in one CSI report,
the CSI reporting configuration to which each CSI report respectively corresponds comprises one of the following parameters:
a codebook configuration parameter for configuring the first CSI;
a codebook configuration parameter for configuring the second CSI; and
a codebook configuration parameter for configuring the third CSI.

10. The apparatus according to claim 1, wherein the first processor circuitry further makes the network device execute the following:
transmitting first signaling by the network device to the terminal equipment, the first signaling being used to indicate the terminal equipment to transmit at least two of the first CSI, second CSI and third CSI based on the CSI reporting configurations.

11. An apparatus for transmitting channel state information (CSI), applicable to a terminal equipment, the apparatus comprising:
second processor circuitry controlling the terminal equipment to execute the following:
receiving, by the terminal equipment, information transmitted by a network device, at least a part of the information being one or more CSI reporting configurations, the one or more CSI reporting configurations being used for indicating the terminal equipment to transmit at least two of first channel state information (CSI), second CSI and third CSI; and
transmitting at least two of the first CSI, the second CSI and the third CSI by the terminal equipment,
wherein at least two of the first CSI, the second CSI and the third CSI are generated based on at least a part of identical channel state information reference signals (CSI-RSs) and/or CSI-RS resources.

12. The apparatus according to claim 11, wherein,
at least a part of information of the first CSI is bit information of a spatial channel matrix or bit information of a right singular vector of the spatial channel matrix; and/or
the second CSI is obtained in a first method; and/or
the third CSI is obtained in a fourth method.

13. The apparatus according to claim 12, wherein,
at least a part of the first method is a method based on an artificial intelligence model.

14. The apparatus according to claim 12, wherein,
at least a part of the fourth method is a codebook specified in 3GPP standardization.

15. The apparatus according to claim 11, wherein,
at least two of the first CSI, the second CSI and the third CSI are included in one or more CSI reports.

16. The apparatus according to claim 11, wherein,
the terminal equipment receives via first radio resource control (RRC) signaling the information transmitted by the network device.

17. The apparatus according to claim 11, wherein,
the CSI reporting configurations comprise a first field for indicating the terminal equipment to transmit the first CSI and/or the second CSI to the network device; and/or
a second field of the CSI reporting configurations indicates the terminal equipment by expanding a value range to transmit a first field of the first CSI and/or the second CSI to the network device.

18. The apparatus according to claim 11, wherein,
in a case where at least two of the first CSI, the second CSI and the third CSI are included in one CSI report,
the CSI reporting configurations comprise at least two of the following parameters:
a codebook configuration parameter for configuring the first CSI;
a codebook configuration parameter for configuring the second CSI; or
a codebook configuration parameter for configuring the third CSI.

19. The apparatus according to claim 11, wherein,
in a case where one of the first CSI, the second CSI and the third CSI is included in one CSI report,
the CSI reporting configuration to which each CSI report respectively corresponds comprises one of the following parameters:
a codebook configuration parameter for configuring the first CSI;
a codebook configuration parameter for configuring the second CSI; and
a codebook configuration parameter for configuring the third CSI.

20. The apparatus according to claim 11, wherein the second processor circuitry further controls the terminal equipment to execute the following:
receiving by the terminal equipment first signaling transmitted by the network device, the first signaling being used to indicate the terminal equipment to transmit at least two of the first CSI, second CSI and third CSI based on the CSI reporting configurations.
